(19) United States
(12) Patent Application Publication
(10) Pub. No.: US 2023/0020455 A1
(43) Pub. Date: Jan. 19, 2023

(54) SYSTEM AND PROCESS FOR TEACHING SPEECH TO PEOPLE WITH HEARING AND/OR SPEECH DISABILITIES

(71) Applicant: Sandra Kaul, Rescue, CA (US)

(72) Inventor: Sandra Kaul, Rescue, CA (US)

(21) Appl. No.: 17/941,134

(22) Filed: Sep. 9, 2022

Related U.S. Application Data
(63) Continuation-in-part of application No. 16/420,266, filed on May 23, 2019.

(51) Int. Cl. G09B 19/04

(52) U.S. Cl. CPC G09B 19/04

(57) ABSTRACT

A system and process to teach building words to individuals with hearing, auditory processing or speech disabilities utilizing unique visual shapes having a unique color to represent each of the phonemes of the English Language and a corresponding set of index cards or objects for each unique visual shape, where each set of index cards or objects have a letter or combination of letters thereon that have the sound of the corresponding unique shape representing the phoneme. Each set of index cards or objects having the letter or combination of letters in the same color as the corresponding unique shape.

### CROSS-REFERENCE TO RELATED APPLICATIONS

The present invention is a continuation-in-part of and claims benefit of priority to co-pending U.S. patent application Ser. No. 16/420,266 filed on May 23, 2019, the entire disclosure of which is hereby incorporated by reference in its entirety.

### STATEMENT REGARDING FEDERALLY SPONSORED RESEARCH OR DEVELOPMENT

Not applicable

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### BACKGROUND OF THE INVENTIVE CONCEPT

### 1. Field of the Invention

The present inventive concept relates to a system for, and process of, teaching individuals with hearing disabilities and/or speech impairments to talk or to express themselves orally with improved intelligibility. More particularly, the present inventive concept relates to a system and process that connects/bridges and individual's previously learned American English language phonemes (distinct units of a sound), via the patented system and process described in Applicant's earlier U.S. Pat. No. 7,172,427, to all letter and letter combinations that make up sounds used in the American English language, in order to help the individual learn to speak, read and spell using the alphabet. In other words, the present inventive concept can be referred to as a set of building blocks to learning all letter and letter combinations that form sounds used in American English language, based on the phonemes previously learned by the teachings of the system and process disclosed in Applicant's earlier U.S. Pat. No. 7,172,427. With the learned distinct units of sounds of the American English language phonemes, the present inventive concept can teach individuals with hearing and/or speech disabilities to become familiar with and use all the letter and letter combinations in the American English language that form the sounds of the American English language, thus helping to teach these individuals to speak, read and spell using all of the letters in the alphabet.

While holding potential for direct application to any individuals who themselves are, or have become, hearing challenged and/or fully or partially incapable of oral communication, the present inventive system and process have been developed for application particularly to children with hearing impairments or other disabilities adversely impacting capability of oral expression. The inventive system and process presented herein, however, are by no means to be considered as limited in scope as to applying only to children.

Across the spectrum of education, for all age levels and types of student subjects, no greater professional challenge exists than that facing a speech pathologist or teacher striving to help a non-hearing child, or speech challenged child to learn to speak. Of course, for the hearing-impaired child, learning to speak certainly is no less a challenge. A great number of such children face this challenge at birth or soon thereafter. From that moment on, their challenge seems insurmountable. After all, how can profoundly deaf children understand anything about speech when they cannot perceive speech sounds, oral words or phrases, even when shouted?

While deaf children might readily observe the lip movements of those speaking directly to them, they obviously associate no sound with such movements. Lip movements, to them, may appear meaninglessly silent. Beyond that, the input gained by a “hearing child” listening to sounds from an observed speaker is lost on the profoundly deaf. Depending on the level of hearing, the auditory input may be inadequate or non-existent, to be able to make any oral/speech sound associations.

The challenged child will focus instead upon more obvious and imposing movements like gestures or actions. Disadvantaged by an absence or limited reception of auditory models for sounds, the deaf child will most likely either: a) not speak at all, or b) develop a manner of speech that is unintelligible to an unsophisticated public. The challenged child will focus instead upon more obvious and imposing movements like gestures, actions and the surrounding colorful world. Even many hearing children do not cognitively register that the sounds they make are different than the sounds people are saying. There are countless individuals who are not deaf that also have problems processing sound and exhibit central auditory processing disabilities. They are unable to neurologically process the sounds they hear. Their ability to process the auditory signal is impacted, and their speech production is negatively affected, However, their other sensory systems, like vision and touch, are intact. These auditory processing problems are apparent in many individuals, with Down Syndrome, apraxia, dyslexia, autism and other speech sound disorders.

Over the years, innovative therapists, linguists, technologists, teachers and pathologists, and hybrids of two or more of such professions have created helpful tools and processes to address this daunting challenge. They have done so with only limited degrees of success. Still, as will be discussed below, ample room exists for improvement in the educational process. There is a substantial need on the part of educators throughout the world for simpler yet more effective tools.

Teaching strategies, developed and applied with limited or mixed success, have involved phonology, phonetics, and to a limited extent have leveraged the concepts of phonemes. “Phonemes,” in this context, are the individual or distinct units of sounds emitted by speaking. Phonemes are traditionally represented in a phonetic script, wherein each descriptor represents a single phoneme.

For years, linguists and/or speech experts have classified speech sounds into representational categories called phonemes. The American English language finds itself represented by about four dozen phonemes, although the exact count varies due to vast numbers of dialects indigenous to geographic regions. Phoneme descriptors range, for example, from monophthongs and diphthongs covering more than a dozen vowel forms, to consonant depictions categorized as approximants, nasals, fricatives, plosives, and affricates. No two categorized spoken sounds are the same. Ironically, these esoteric descriptors just mentioned seem to a layperson as a language from a distant world, yet they are in fact subset groupings of all spoken language sounds.

An International Phonetic Alphabet, or IPA, was developed and first published in 1888 by the International Phonetic Association, an organization founded by Paul Passy. The IPA was modeled on the 1847 works of Isaac Pitman and Henry Ellis, and eventually was revised in 1993, and again in 2015. The IPA is used by speech pathologists and others to transcribe the spoken word in dictionaries to describe the pronunciation of words, and to depict unwritten languages.

The most current chart showing the standard phonemes of the IPA is referenced as prior art within this application at FIGS. 2A and 2B, to be further discussed below, and may be accessed and reviewed in more detail at an Internet website http://www.internationalphoneticassociation.org (See: Reproduction of the International Phonetic Alphabet. While unknown, or at best little appreciated, by a typical layperson, oral communication fairly flows on the science of the production of phonemes. In brief, it consists of the placement of tongue and teeth within a mouth with specific posture and combines with breath and voicing, which may resonate in the nose or mouth. By stringing these movements and sounds together, they collaborate to form and project the words common to a person's lexicon. In typical oral communications, the listening recipient takes in the uttered phonemes and tones. The recipient hears, interprets, learns, reacts and responds in kind. But, meaningful comprehension and exchange are in no way easy for the hearing or speech impaired, especially if such impairment is significant or profound; nor is it easy for individuals with severe speech sound disorders.

With the aid of the system and process disclosed in U.S. Pat. No. 7,172,427, individuals with hearing and/or speech impairments can learn how to form the sounds of the phonemes (symbols) of the American English language. However, in order to be capable of speaking full words and phrases, there is much more to be learned, above and beyond forming the sounds of the phonemes alone. More specifically, there are more than 250 letter and letter combinations forming sounds that make up words in the American English language. Each of these sounds is built from previously learned phonemes (the distinct units of a sound). Once individual sounds are learned, these phoneme symbols can be combined to product words.

### 2. Description of the Related Art

U.S. Pat. No. 7,172,427, issued to the instant Applicant of this patent application, teaches a system and process that provides visual phonemes that can be in the form of physical qualities in terms of, for example, colors, shapes, textures, weights, rigidity, flexibility, softness, pliability, or whole/part. FIGS. 1a-e illustrate visual phonemes according to the teachings of U.S. Pat. No. 7,172,427. Each phoneme is displayed with a unique shape along with a uniquely identifiable color. In this teaching, spoken sounds in the form of vowels (FIGS. 1-a and 1-b) are disclosed to be represented by distinctive ranges of color hues, such as by colors commonly characterized in the art as warm. For example, warm colors include red, pink, orange, gold and yellow, and variants of each of these colors. In addition, spoken sounds in the form of consonants (FIGS. 1-c, d, e) are disclosed to also be represented by distinctive ranges of color hues, such as by colors commonly characterized in the art as cool. For example, cool colors include purple, blue, green, turquoise, gray, silver and white, and variants of each of these colors.

Additionally, each of the approximately 40 phonemes shown in FIGS. 1a-e (in the American English language) is labeled in such a way as to be correlated with the International Phonetic Association Alphabet, or IPA (see IPA Prior art as presented in FIG. 2). For example, in FIG. 1-c, visual phoneme 2 is designated as royal blue in color 3, and carries the IPA correlation, “[m]” as indicated by reference character 4. See U.S. Pat. No. 7,172,427 for the full teachings and disclosure of the system and process that teaches individuals with hearing impairments and/or speech complications the 40 primary phonemes of the American English language.

What is needed is a system and process that bridges/connects these 40 or more phonemes of the American English language with the at least 250 letter and letter combinations, which make up the sounds in the American English language in order to teach individuals with hearing impairments and/or speech difficulties how each of the at least 250 letter and letter combinations are associated with, and are formed by the approximately 40 phonemes of the American English language. Such a system and process will help such individuals with hearing impairments and/or speech difficulties how to speak, spell and read each of these 250 letter and letter combinations, which will in effect help these individuals to learn how to pronounce all versions of letters and letter combinations to form words, and hence to learn to speak in phrases.

### SUMMARY OF THE INVENTIVE CONCEPT

The present general inventive concept provides a system and process to teach individuals with hearing disabilities and/or speech impairments to talk, read and spell using the alphabet. More particularly, the present inventive concept provides a system and process that connects/bridges an individual's previously learned American English language phonemes to all letter and letter combinations that make up words in the American English language, in order to help the individual learn to read and spell using the alphabet.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a system for teaching speech to individuals with hearing, auditory processing or speech disabilities using phonemes, the system comprising: a plurality of unique shaped objects, each unique shaped object representing the same sound as one of the phonemes of the American English language among the plurality of well-established American English language phonemes and being provided in a unique color, and a plurality of sets of index cards, each set of the plurality of sets of index cards corresponding to one of the unique shaped objects representing the sound of a corresponding phoneme and including: an index card having one of the letters or combination of letters thereon that have the same sound as the corresponding unique shaped object for every letter or combination of letters which have the same sound as the corresponding unique shaped object representing the same sound as the corresponding phoneme and having that letter or combination of letters printed in the same color as that unique shaped object.

In an exemplary embodiment, the system may further comprise: a kit to contain each of the plurality of sets of index cards and together with a corresponding index divider card for each set of index cards, each divider card having: a tab including the unique shaped object and corresponding phoneme thereon, and a body section including each of the letters and combinations of letters thereon together with examples of words including those letters and combinations of letters.

The foregoing and/or other features and utilities of the present general inventive concept may also be achieved by providing a system for teaching speech to individuals with hearing, auditory processing or speech disabilities using phonemes, the system comprising: a plurality of unique shaped three dimensional objects, each unique shaped three dimensional object representing the same sound as one of the phonemes of the American English language among the plurality of well-established American English language phonemes and being provided in a unique color and including the corresponding phoneme thereon and each of the letters and combinations of letters thereon together with examples of words including those letters and combinations of letters, and a plurality of sets of index cards or secondary three dimensional objects, each set of the plurality of sets of index cards or secondary three dimensional objects corresponding to one of the unique shaped three dimensional objects representing the sound of a corresponding phoneme and including: an index card or secondary three dimensional objects having one of the letters or combination of letters thereon that have the same sound as the corresponding unique shaped three dimensional object for every letter or combination of letters which have the same sound as the corresponding unique shaped three dimensional object representing the same sound as the corresponding phoneme and having that letter or combination of letters printed in the same color as that unique shaped object.

In an exemplary embodiment, the plurality of unique shaped three dimensional objects and the plurality of sets of index cards or secondary three dimensional objects are formed of a flexible magnetic material.

In another exemplary embodiment, a back surface of the plurality of unique shaped three dimensional objects and the plurality of sets of index cards or secondary three dimensional objects are formed of a magnetic material are formed of a hook and loop system such that the three dimensional elements and the plurality of sets of second three dimensional elements attract to and stick to the inside surface of the cover.

In another exemplary embodiment, the plurality of unique shaped three dimensional objects and the plurality of sets of index cards or secondary three dimensional objects are formed of a flexible material.

In yet another exemplary embodiment, the plurality of unique shaped three dimensional objects and the plurality of sets of index cards or secondary three dimensional objects are formed of a magnetic material are formed of a felt material.

In still another exemplary embodiment, the plurality of unique shaped three dimensional objects and the plurality of sets of index cards or secondary three dimensional objects are formed of a magnetic material are formed of a rubber material.

The foregoing and/or other features and utilities of the present general inventive concept may also be achieved by providing a process of teaching speech to individuals with hearing, auditory processing or speech disabilities, the process comprising: presenting a picture of an object to be spelled out and requesting the individual to first pronounce the object; providing a plurality of unique shaped objects to the individual, each unique shaped object representing the same sound as one of the phonemes of the American English language among the plurality of well-established American English language phonemes and being provided in a unique color; instructing the individual to select each of the unique shaped objects which represent the phonemes that make the sound of the object in the picture one at a time so the selection of unique shaped objects are lined up to make the sound of the object in the picture; providing a plurality of sets of index cards, each set of the plurality of sets of index cards corresponding to one of the unique shaped objects representing the sound of a corresponding phoneme and including: an index card having one of the letters or combination of letters thereon that have the same sound as the corresponding unique shaped object for every letter or combination of letters which have the same sound as the corresponding unique shaped object representing the same sound as the corresponding phoneme and having that letter or combination of letters printed in the same color as that unique shaped object; and instructing the individual to select each of the index cards having the letter or combination of letters thereon which match the color of the selected unique shaped objects; and instructing the individual to build the word that sounds the object presented in the picture by aligning each of the index cards having the letter and/or combinations of letters directly under the corresponding lined up selected unique shaped objects.

It is to be noted that that the colors of the shapes that represent each phoneme and the letters and letter combinations that make these phonemes in words are always the same. For example, the [p] phoneme is lime-green and any letter or letter combination that makes the [p] sound in words is lime-green. Depending on the material used to represent them, the tone, hue or intensity of the colors my vary. New phoneme colors also may be added.

It is also to be noted that this system may be adjusted to be representative of sounds and letters in other languages.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIGS. 1A through 1E illustrate a system and process, according to related art, for teaching speech to people with hearing or speech disabilities.

FIG. 2A illustrates a table of the International Phonetic Association Alphabet (IPA) for vowels, according to prior art.

FIG. 2B illustrates a table of the International Phonetic Association Alphabet (IPA) for consonants, according to the prior art.

FIGS. 3A through 3Q illustrate index card dividers for a system and process for teaching all of the American English language phoneme vowel and vowel combination sounds to those with hearing and/or speech disabilities, according to an exemplary embodiment of the present inventive concept. Each of these index card dividers display examples of words that represent the various letter or letter combinations that make the phoneme that is represented.

FIG. 4A through 4X illustrate index card dividers for a system and process for teaching all of the American English language consonant sound combinations to those with hearing and/or speech disabilities, according to an exemplary embodiment of the present inventive concept.

FIG. 4Y illustrates the index card divider of FIG. 3F together with corresponding index cards each having one of the vowel or vowel combinations that sound the phoneme [i] represented by the shape [symbol] as illustrated in FIG. 3F.

FIG. 4Z illustrates the index card divider of FIG. 4R together with corresponding index cards each having one of the consonant or consonant combinations that sound the phoneme [ [symbol] ] represented by the shape [symbol] as illustrated in FIG. 4R.

FIG. 5 illustrates an exemplary embodiment of a system for teaching all of the American English language vowel sound combinations to those with hearing and/or speech disabilities, according to an exemplary embodiment of the present inventive concept.

FIG. 5A illustrates an example process of using the system according to FIG. 3A through FIG. 5.

FIGS. 6A through 6C illustrate a system and process for teaching all of the American English language phoneme vowel and vowel combination sounds to those with hearing and/or speech disabilities, according to another exemplary embodiment of the present inventive concept.

FIGS. 6D through 6F illustrate a system and process for teaching all of the American English language consonant and consonant combination sounds to those with hearing and/or speech disabilities, according to another exemplary embodiment of the present inventive concept.

FIG. 6G illustrates an exemplary embodiment of a system for teaching all of the American English language vowel sound combinations to those with hearing and/or speech disabilities, according to another exemplary embodiment of the present inventive concept.

FIG. 7 illustrates an example of the process of the present inventive concept performed by a student with hearing and/or speech disabilities of using the colored shapes representing the phonemes that sound out the word “bat” together with applying the corresponding cards having the vowels and consonants that match the color of the shapes representing the phonemes to then spell the word “bat.”

FIG. 8A illustrates the shapes representing the phonemes that a student with hearing and/or speech disabilities must use to build the sounds of the word “octopus,” which is the teachings from applicant's former U.S. Pat. No. 7,172,427.

FIG. 8B illustrates an example of the process of the present inventive concept where a student with hearing and/or speech disabilities matches correct letter choices having the same color as the colored shapes of the phonemes that sound the word “octopus” to then spell the word “octopus.”

FIG. 9A illustrates the phonemes that a student with hearing and/or speech disabilities must use to build the word “mop,” which is the teachings from applicant's former U.S. Pat. No. 7,172,427.

FIG. 9B illustrates an example of the process of the present inventive concept where a student with hearing and/or speech disabilities matches correct letter choices having the same color as the colored shapes of the phonemes that sound the word “mop” to then spell the word “mop.”

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept may be omitted, but are by no means outside the spirit and scope of the present inventive concept as described herein.

It will be understood that although terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of this disclosure.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description herein. Thus, the terms used herein have to be defined based on the meaning of the terms together with the descriptions throughout this specification.

Also, when a part “includes” or “comprises” an element, unless there is a particular description contrary thereto, the part can further include other elements, not excluding the other elements.

Hereinafter, one or more exemplary embodiments of the present general inventive concept will be described in detail with reference to accompanying drawings.

Exemplary embodiments of the present general inventive concept are directed to both two and three dimensional systems and processes that bridge/connect an individual's learning of the 40 or more American English language phonemes, represented by shapes and color combinations disclosed in Applicant's prior patented system and process disclosed in Applicant's previously issued U.S. Pat. No. 7,172,427, to the at least 250 letter and letter combinations that make up the sounds in the American English language. Thus, the exemplary embodiments of the present inventive concept provide both two and three dimensional systems and processes that bridge/connect the at least 250 letter and letter combinations which make up the sounds to form words in the American English language, to the visually created phonemes disclosed in teaching of Applicant's U.S. Pat. No. 7,172,427. Thus the exemplary embodiments of the present inventive concept help to teach individuals with profound hearing impairments or other disabilities limiting speech capabilities each of the letter and letter combinations that form sounds of the American English language, and to help these individuals to speak, read and spell using the alphabet. The present system and process, as described herein, can be utilized along with or in conjunction with known or conventional methods and tools for teaching individuals phonemic awareness and articulation of speech and sounds.

As with Applicant's previous system and process disclosed in U.S. Pat. No. 7,172,427, hearing-challenged individuals and individuals with speech sound disorders are the principal targets for this present inventive system and process. While the Applicant's issued U.S. Pat. No. 7,172,427 provides a system and process to learn sounds from visual phonemes (i.e., specific shapes and colors), the present inventive system and process can be referred to generally as the bridging of the 250 or more American English language “letter and letter combinations” used to form words to the visually formed phonemes taught in the system and process disclosed in U.S. Pat. No. 7,172,427. The development of phonemic awareness taught by U.S. Pat. No. 7,172,427 using color and shape is an essential part of the interrelationship with the present inventive system.

It is to be noted that although specific colors and shapes are disclosed herein to represent certain American English language phonemes and letter and letter combinations, the present inventive concept is not limited to this specific arrangement, and can alternatively use other colors and shapes to represent each of the American English language phonemes together with letter and letter combinations used in the American English language, while still remaining within the spirit and scope of the present inventive concept as disclosed herein.

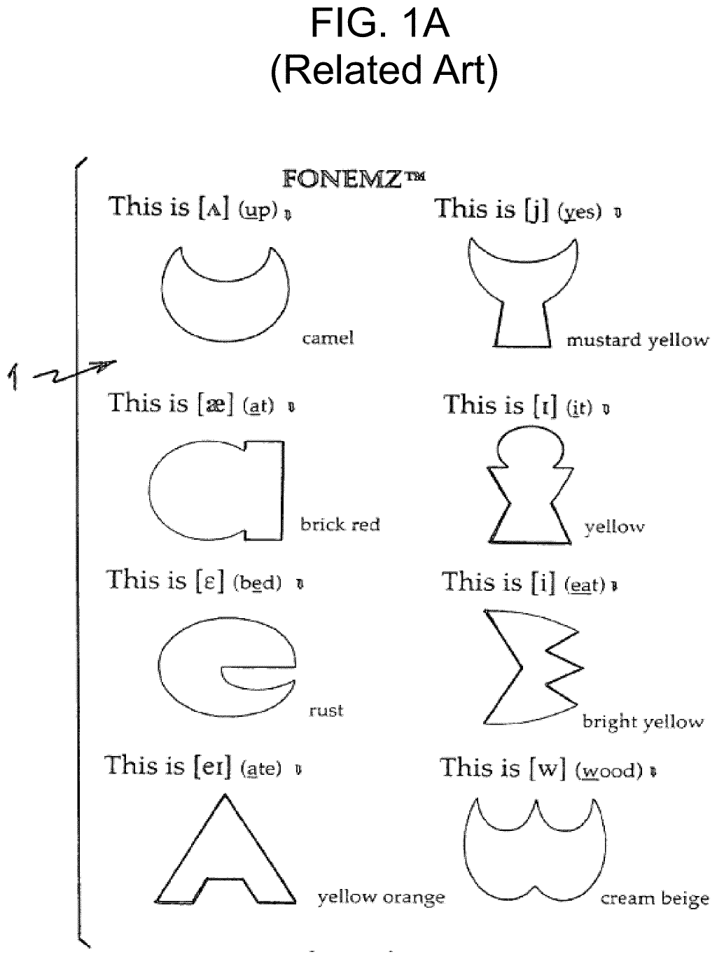

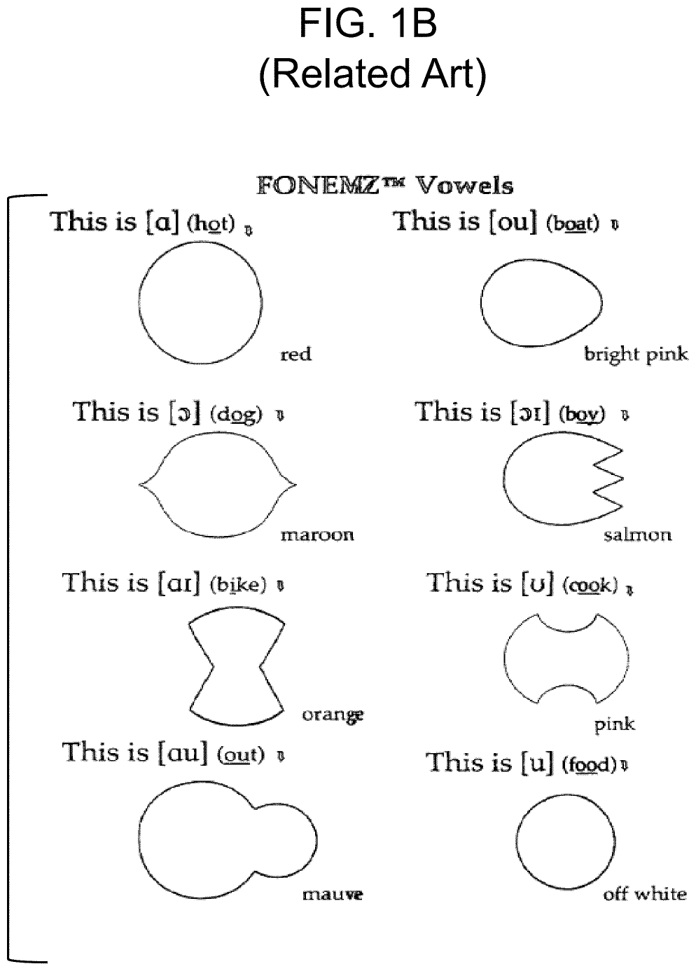

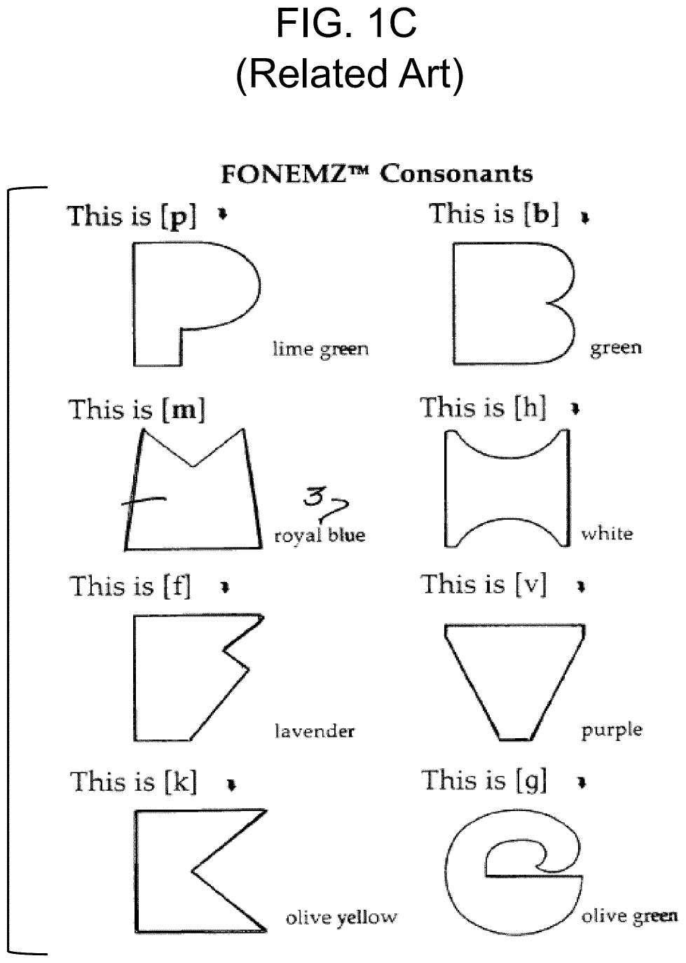

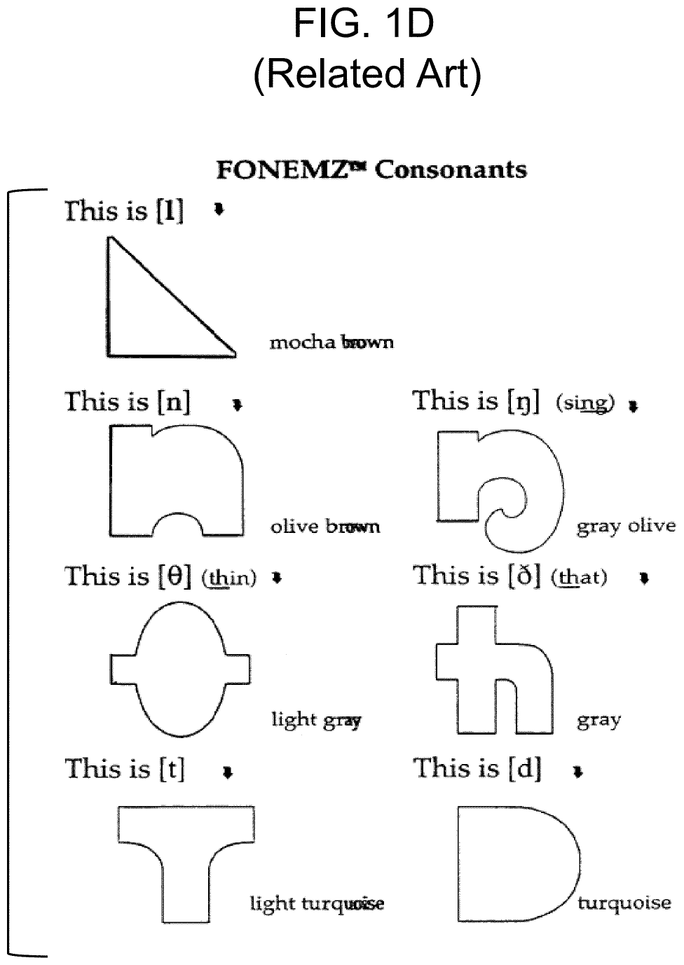

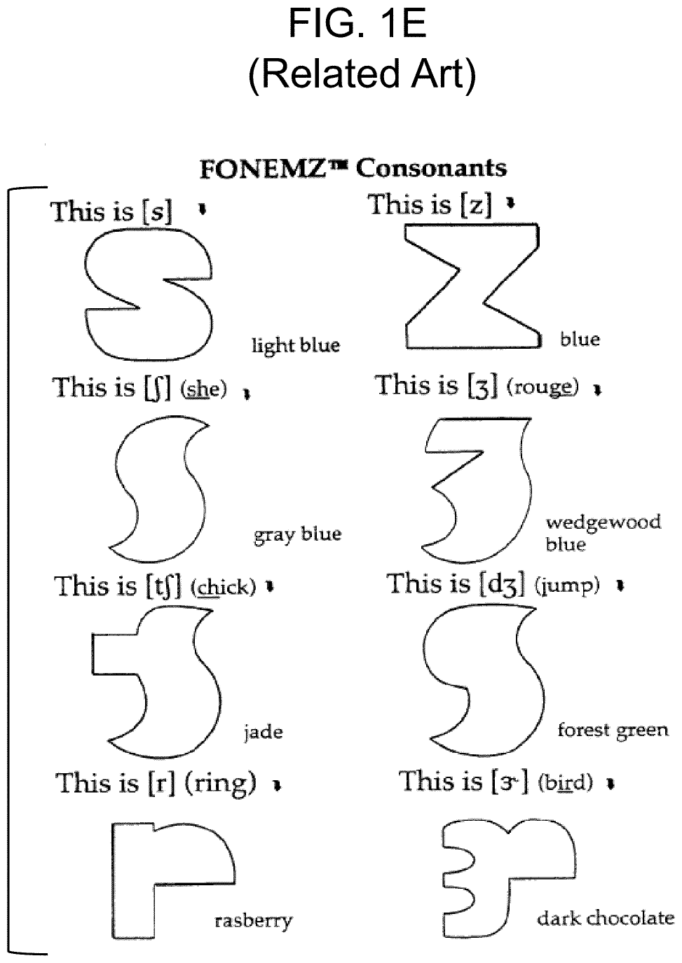

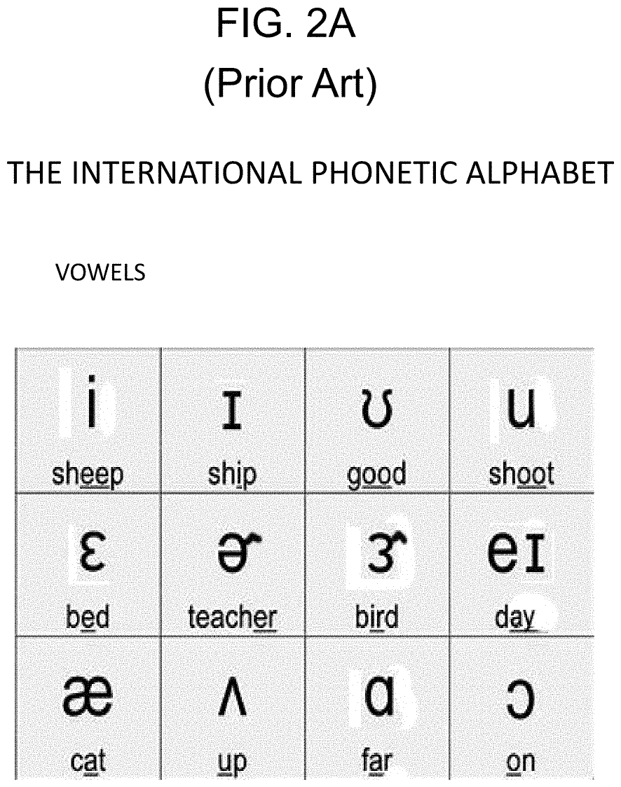

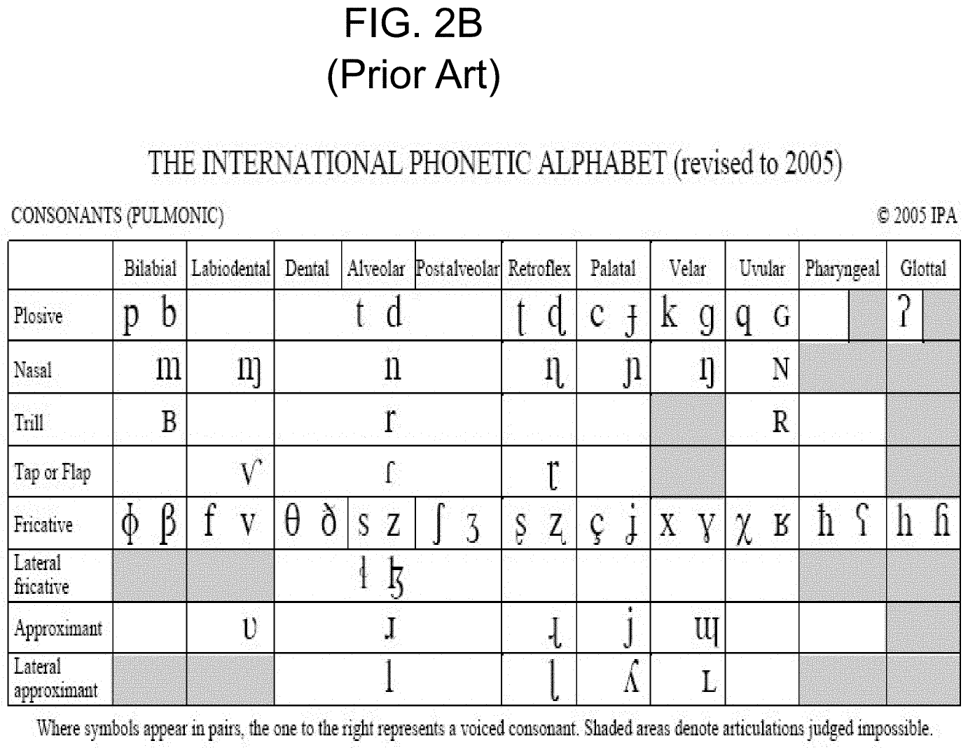

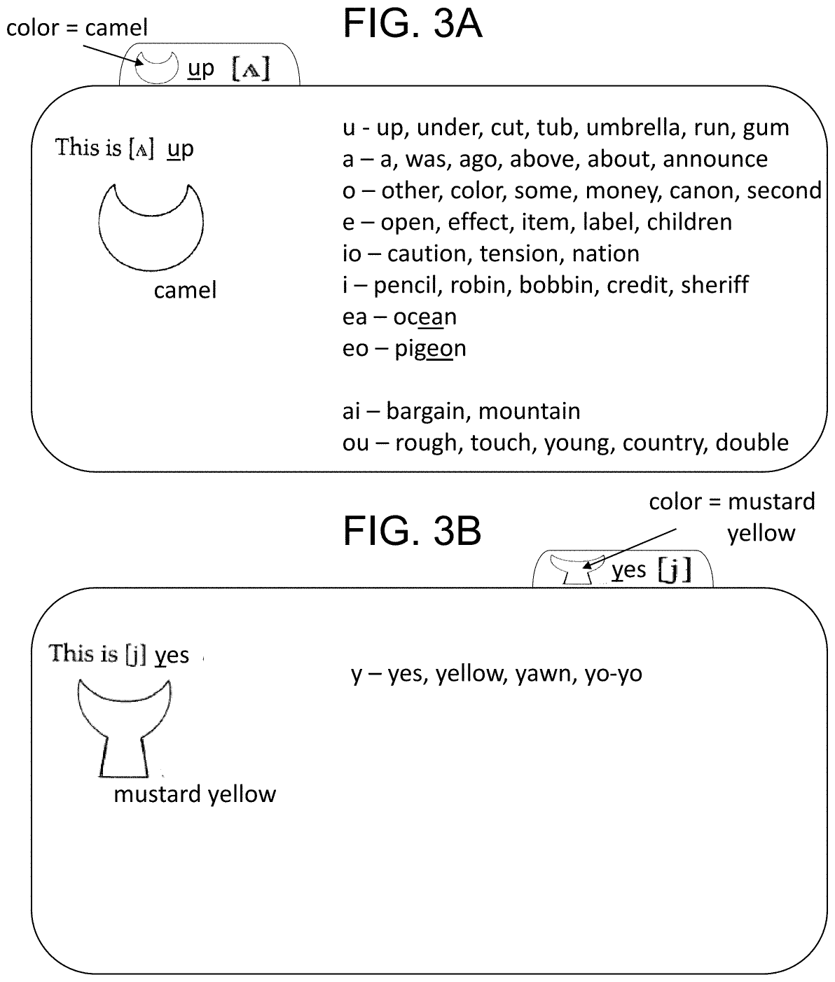

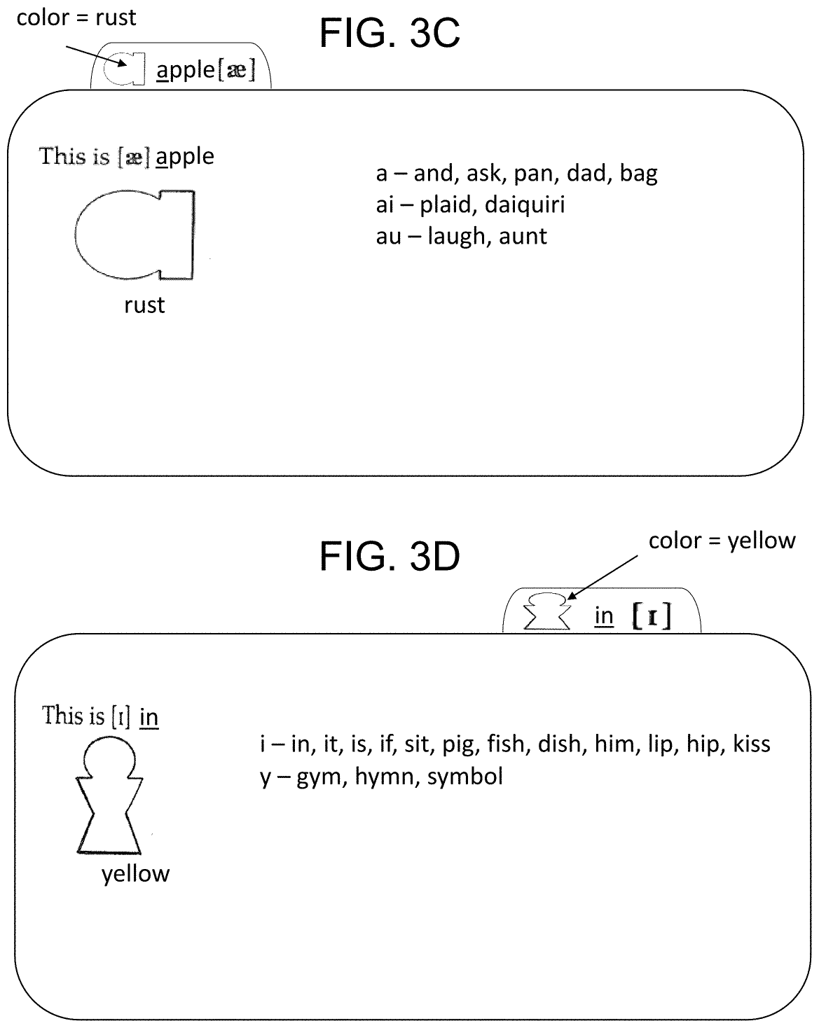

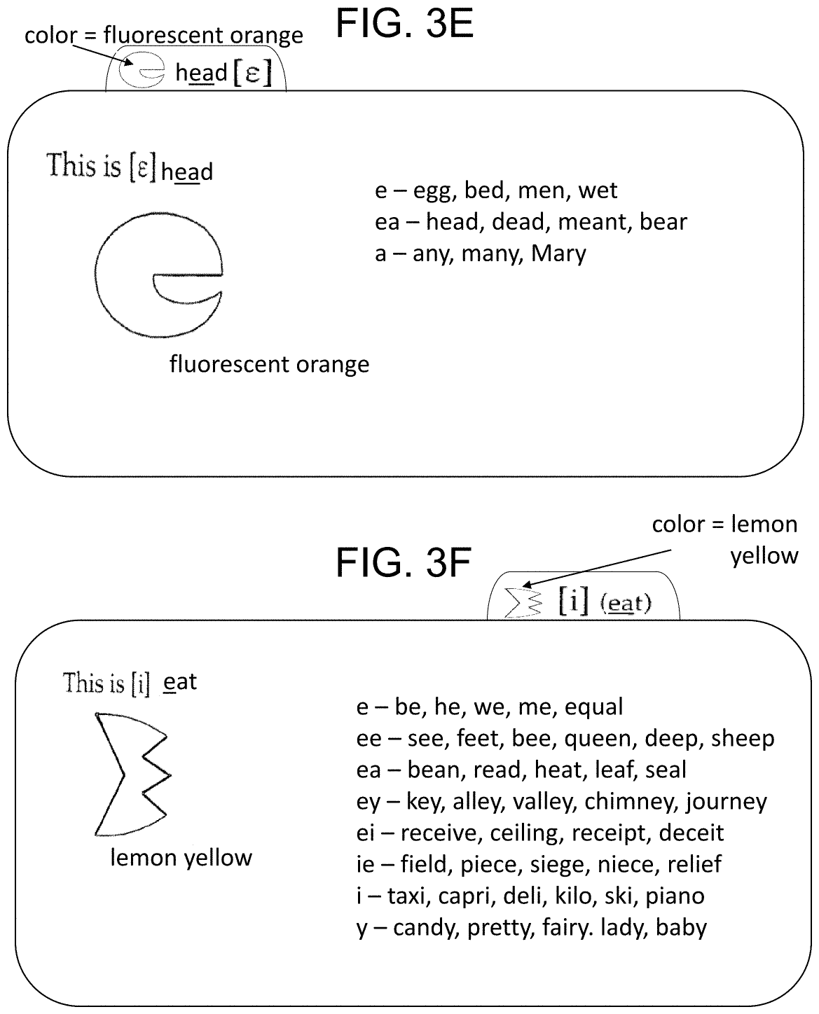

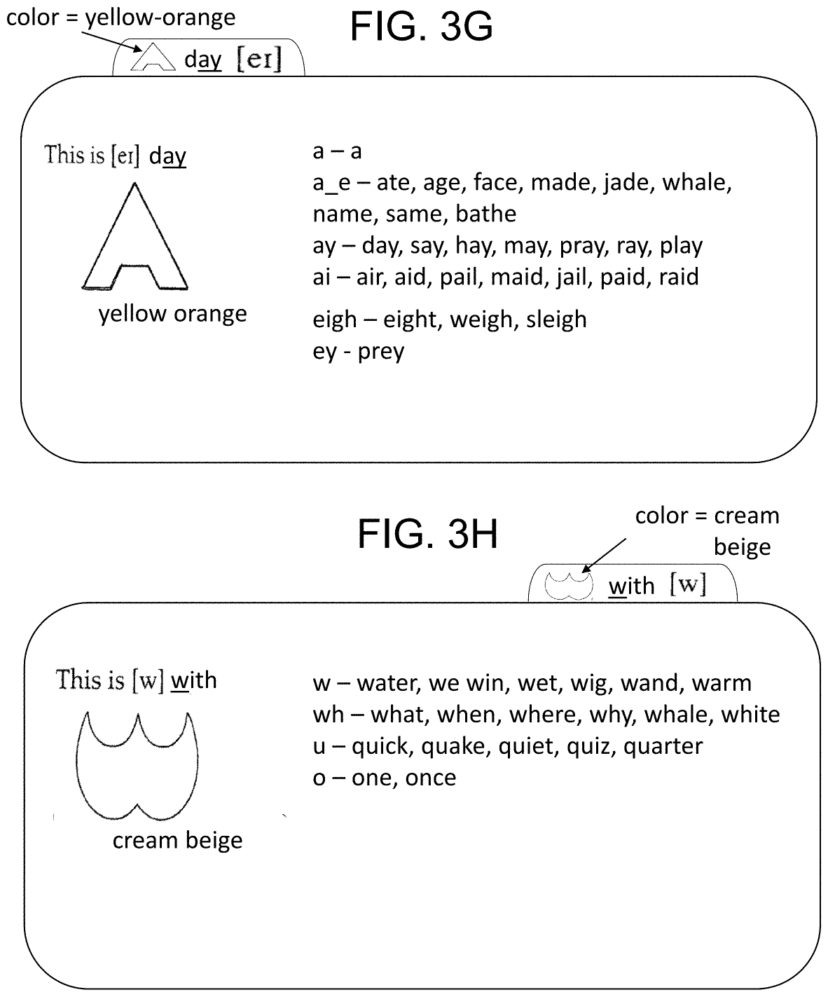

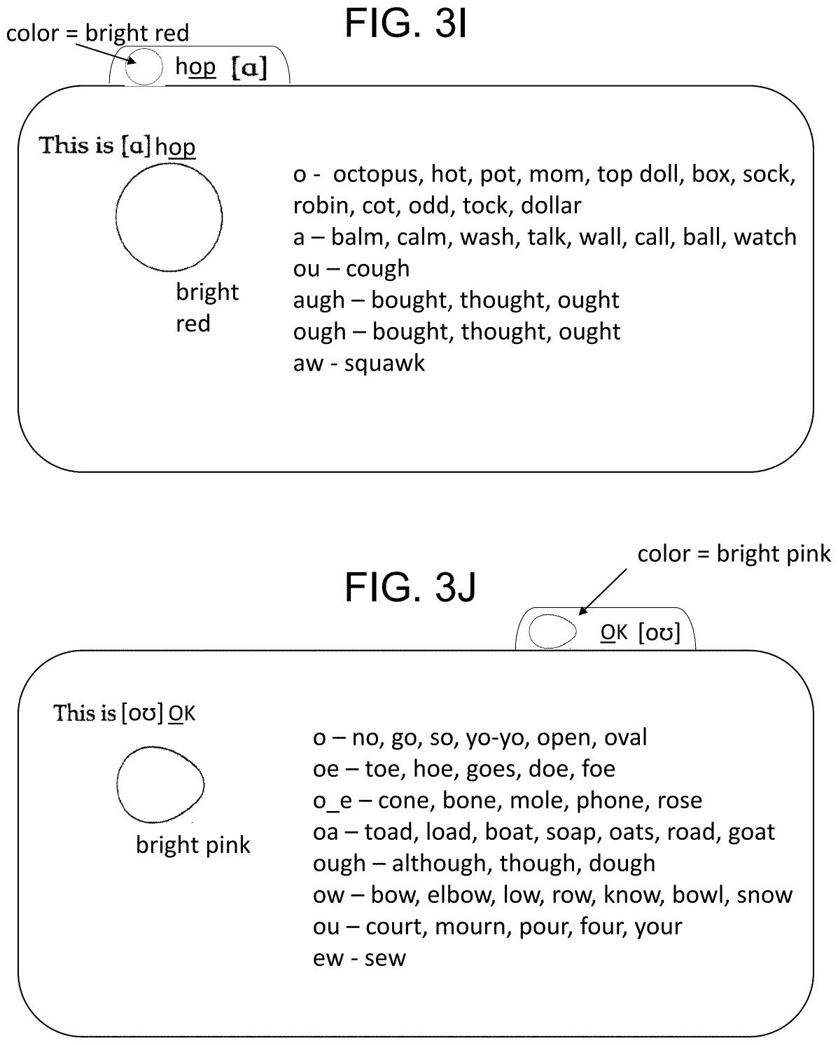

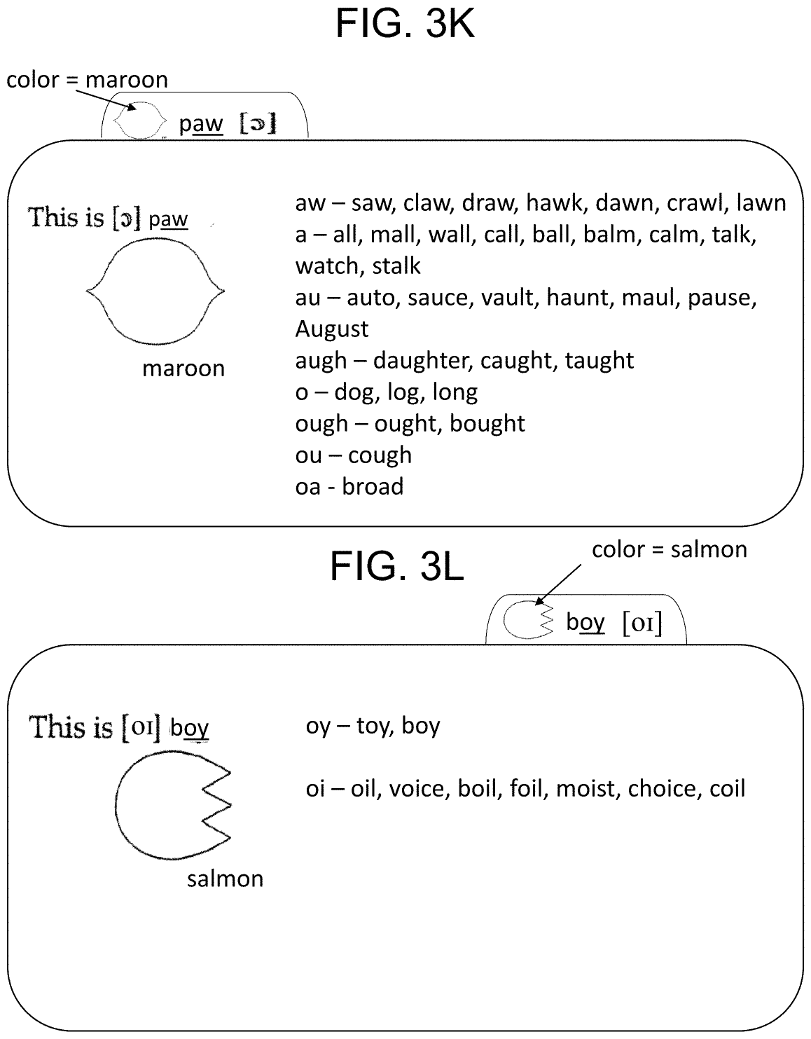

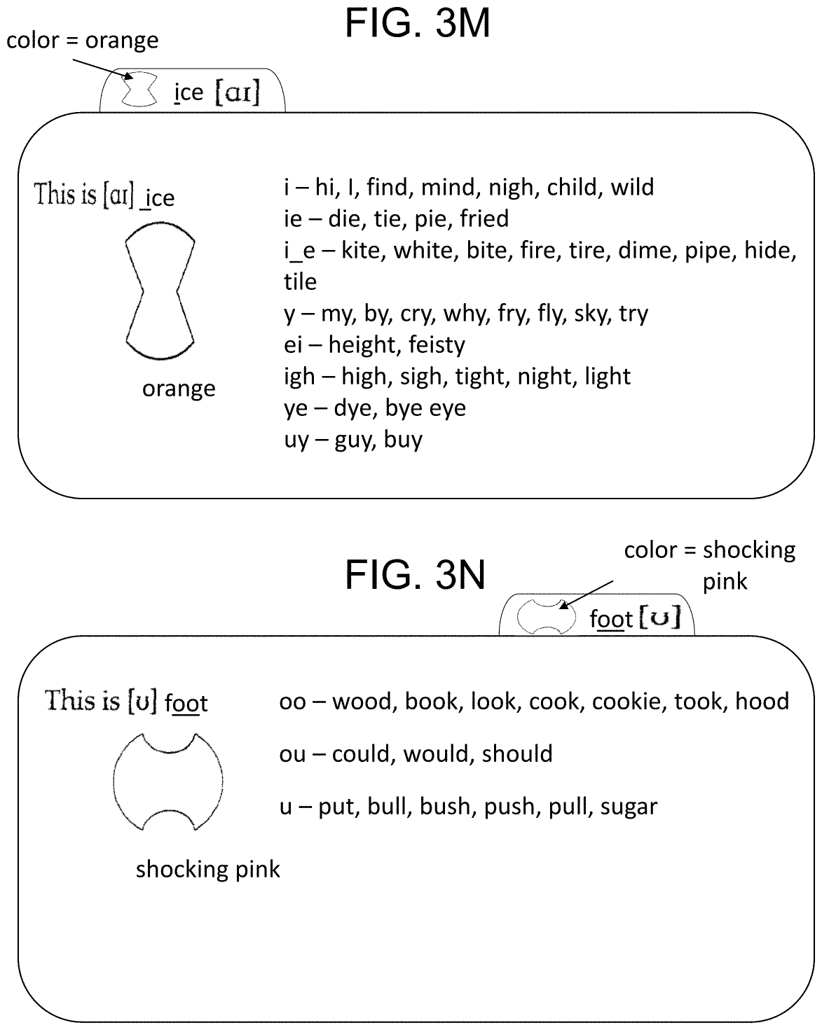

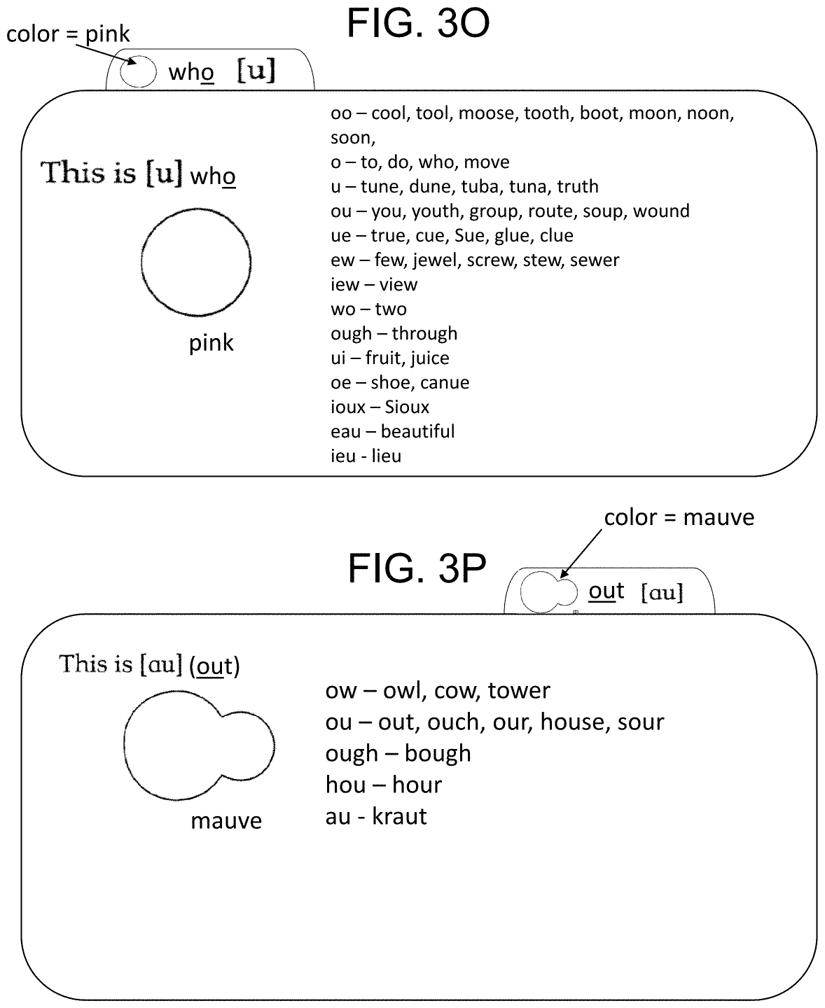

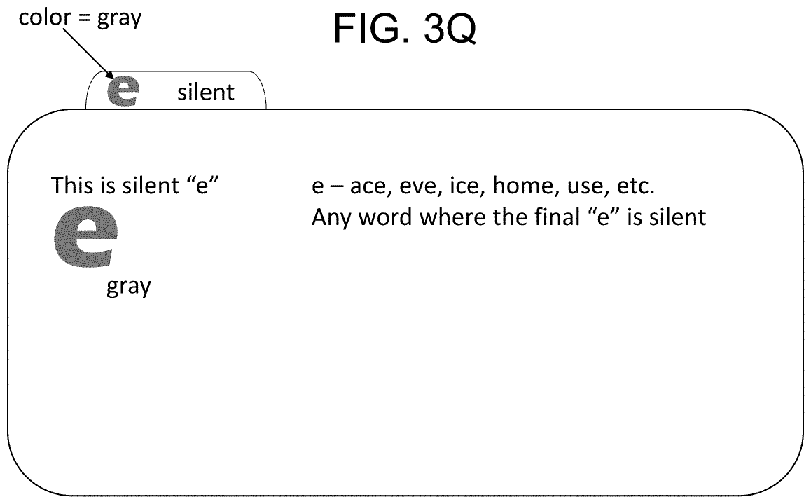

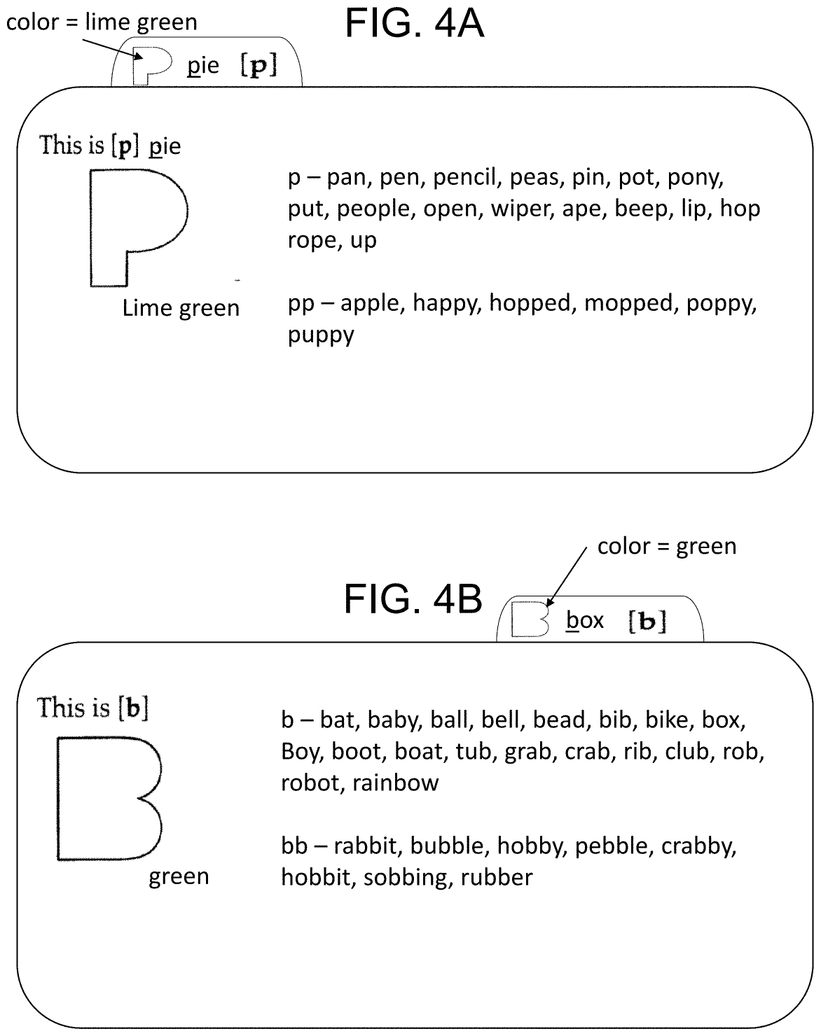

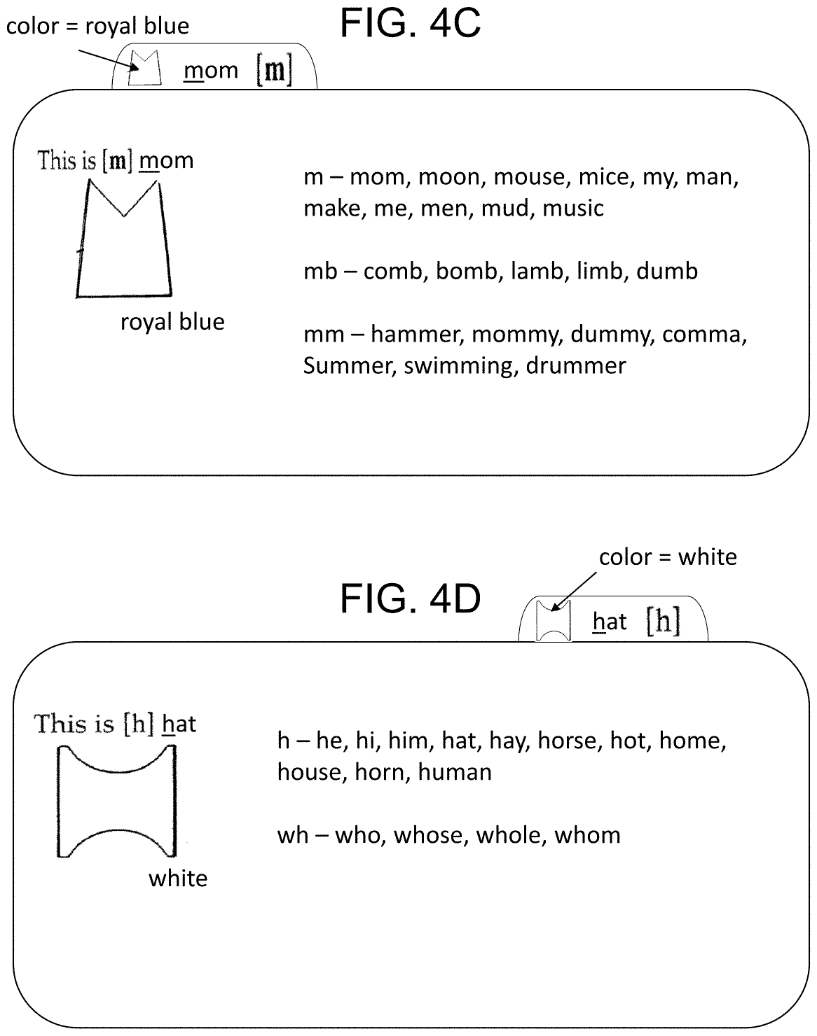

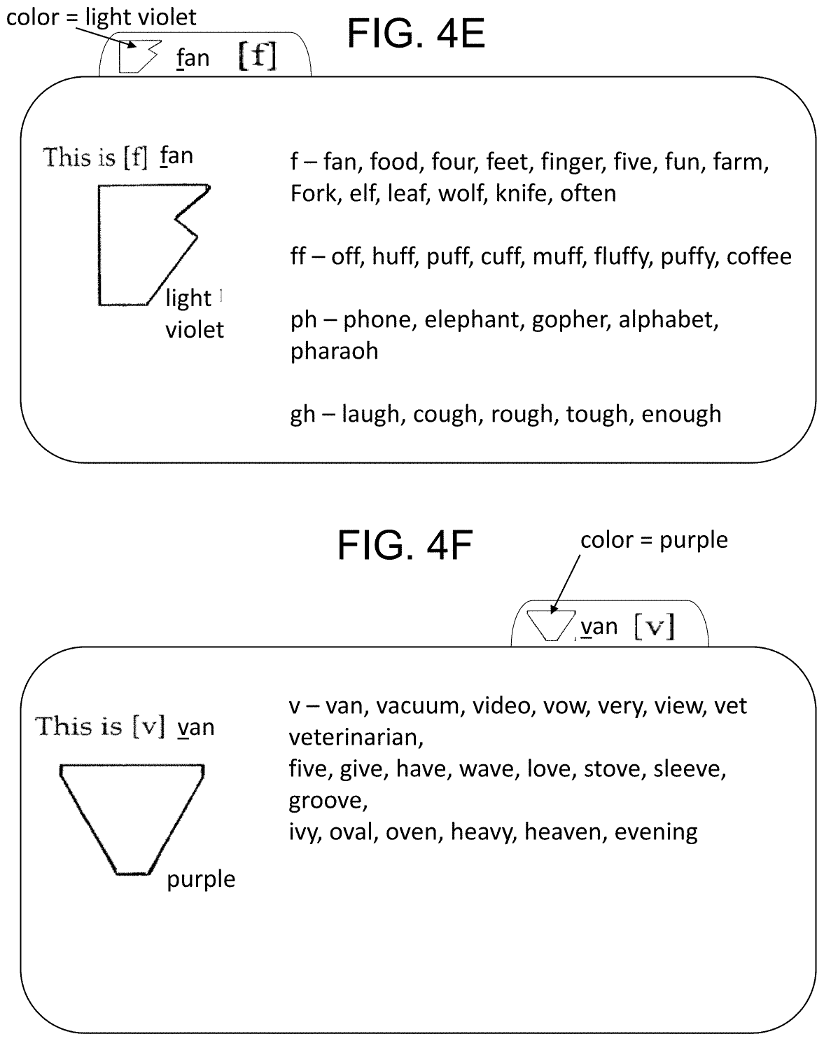

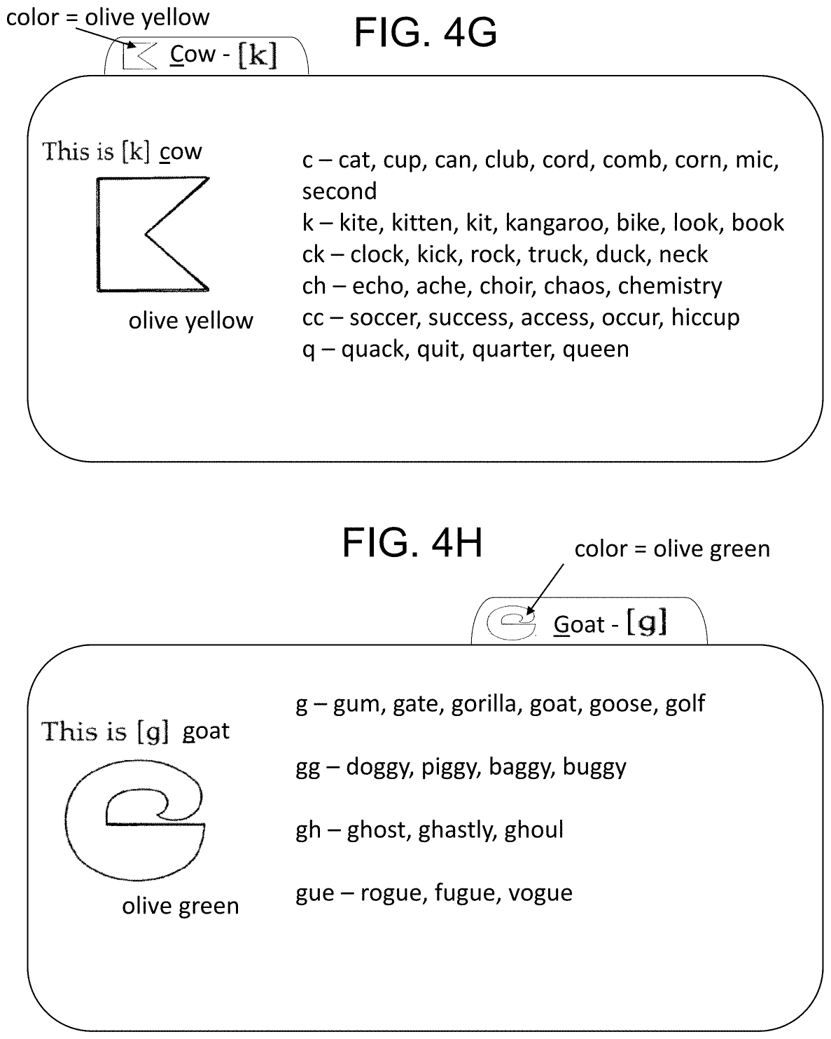

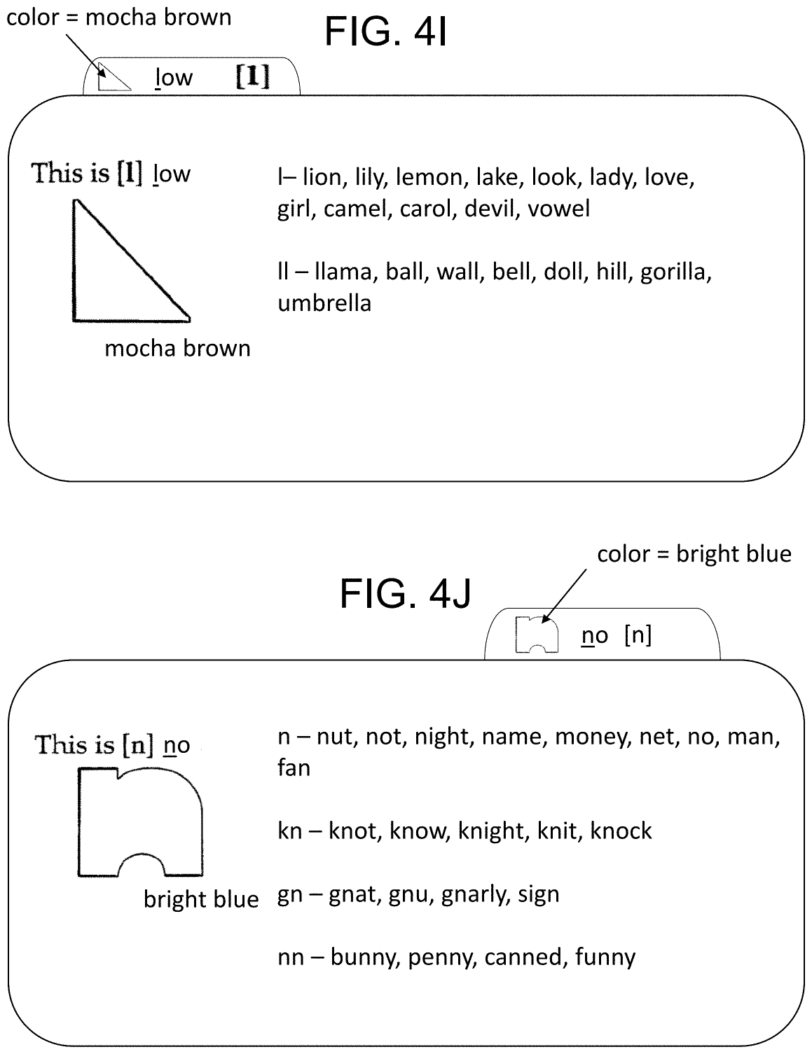

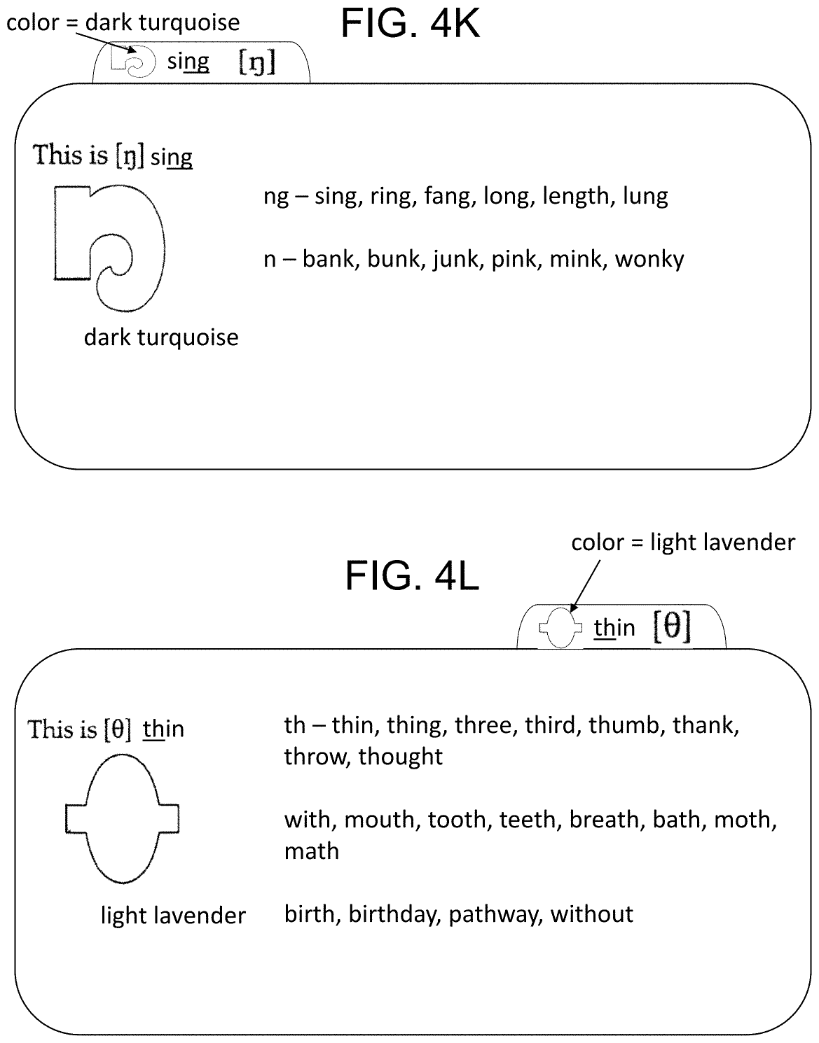

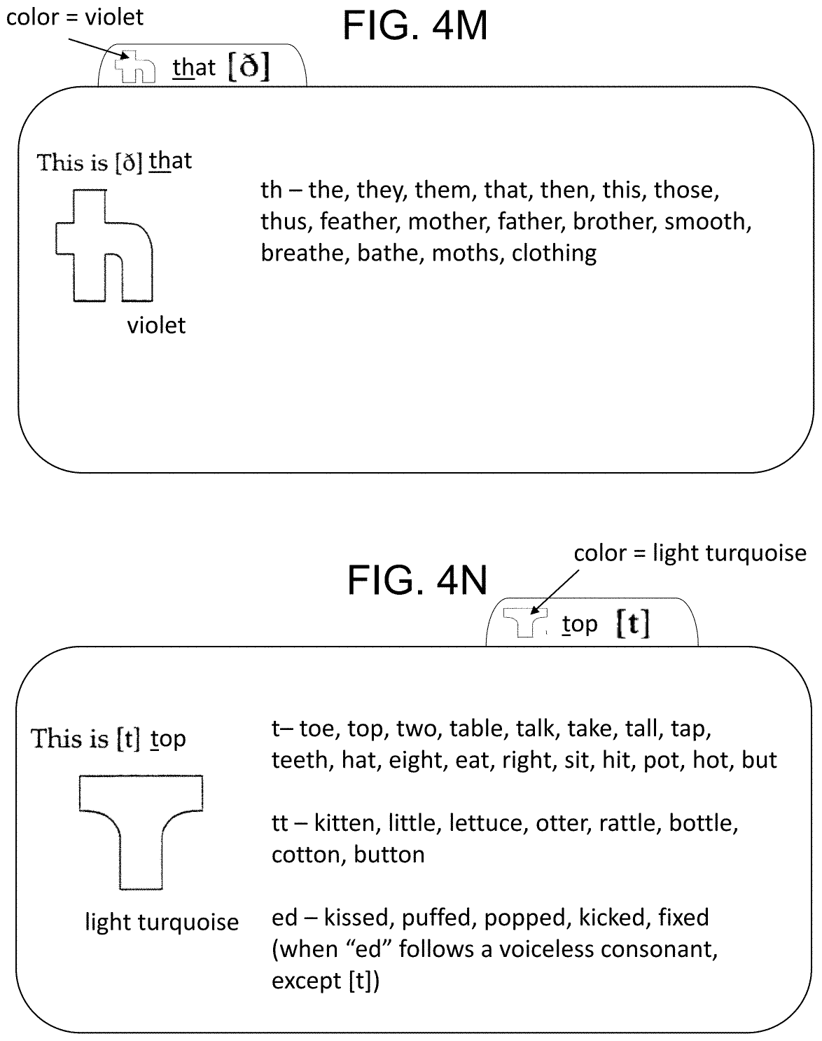

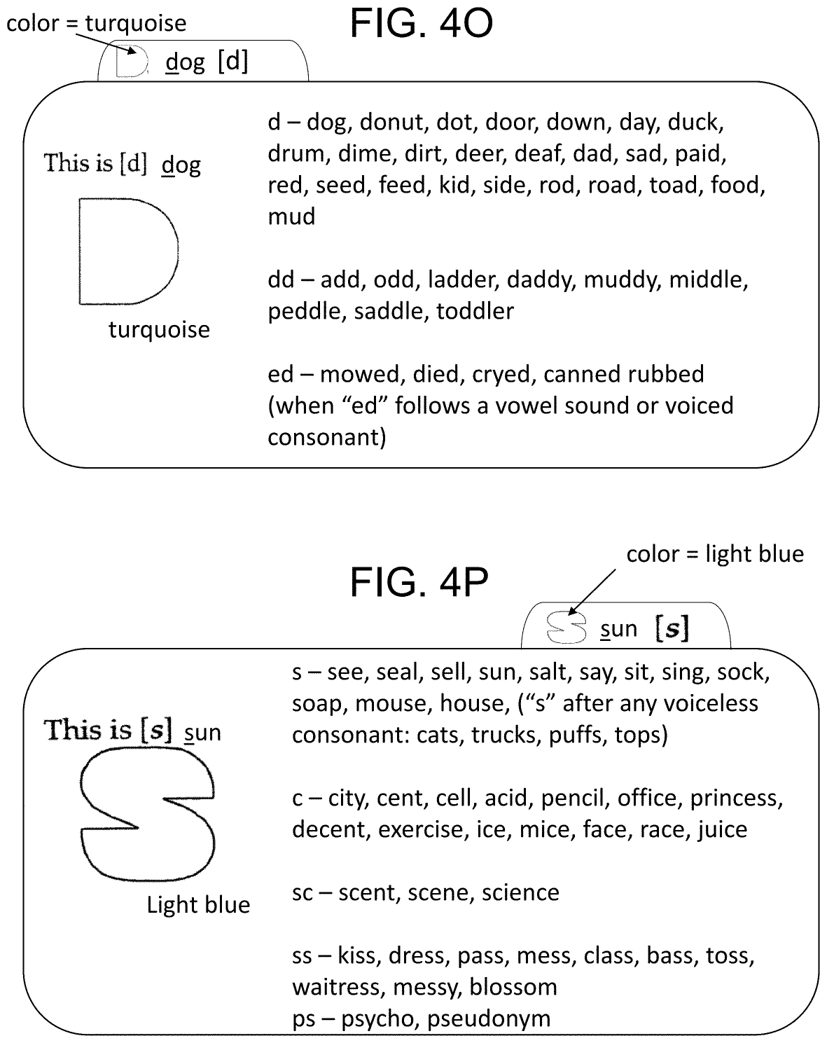

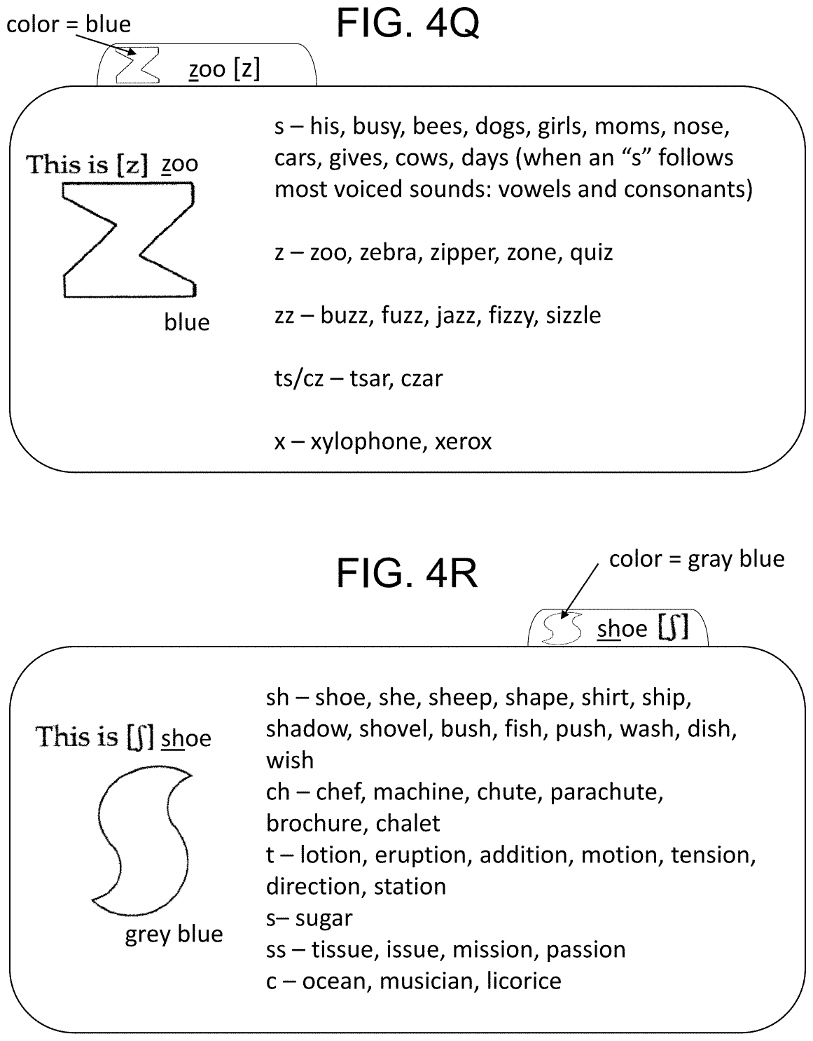

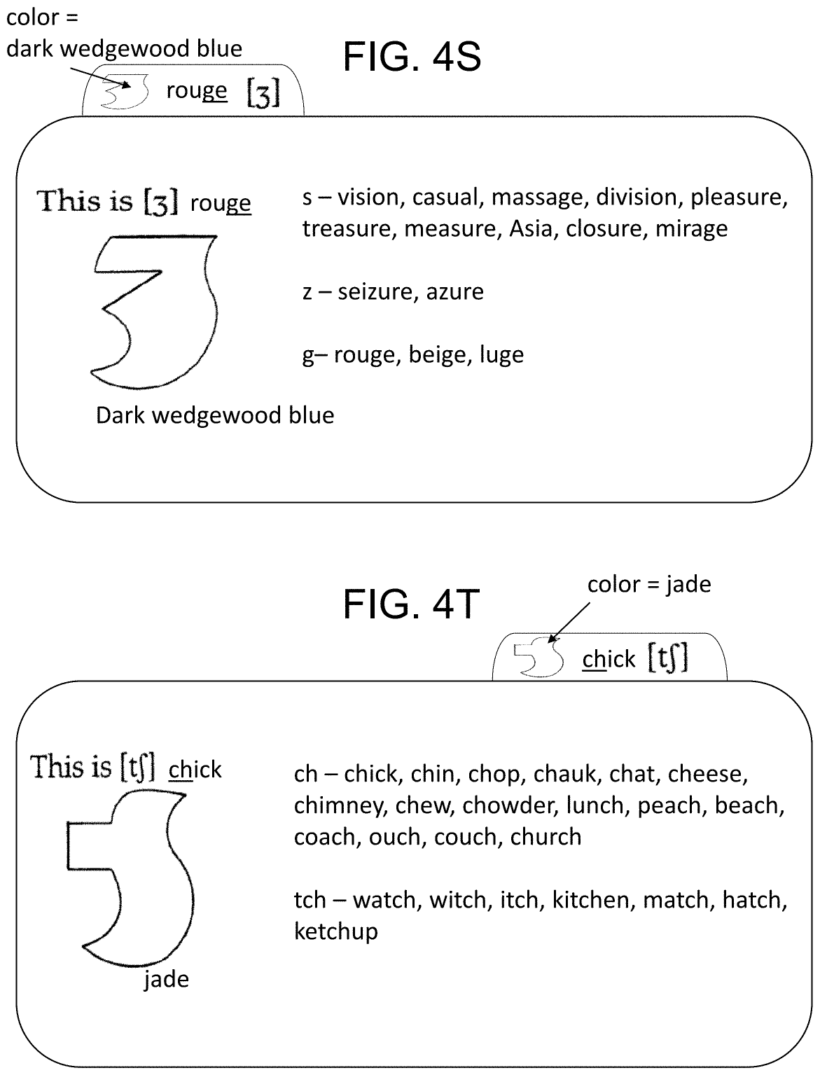

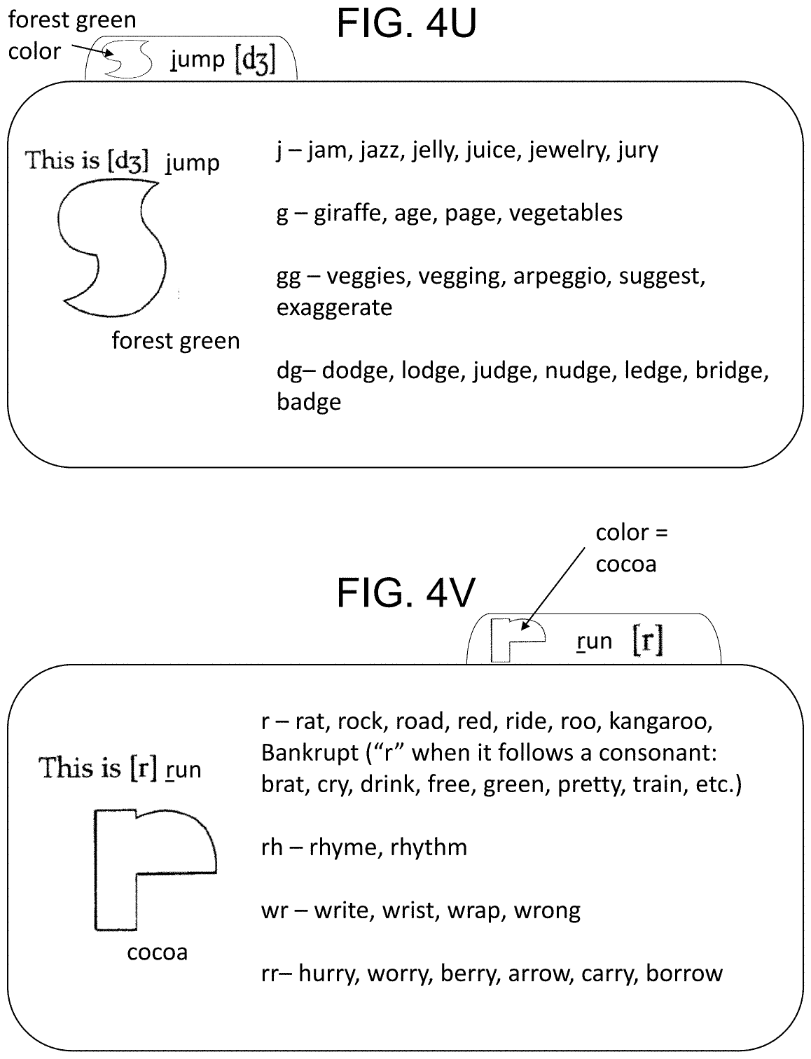

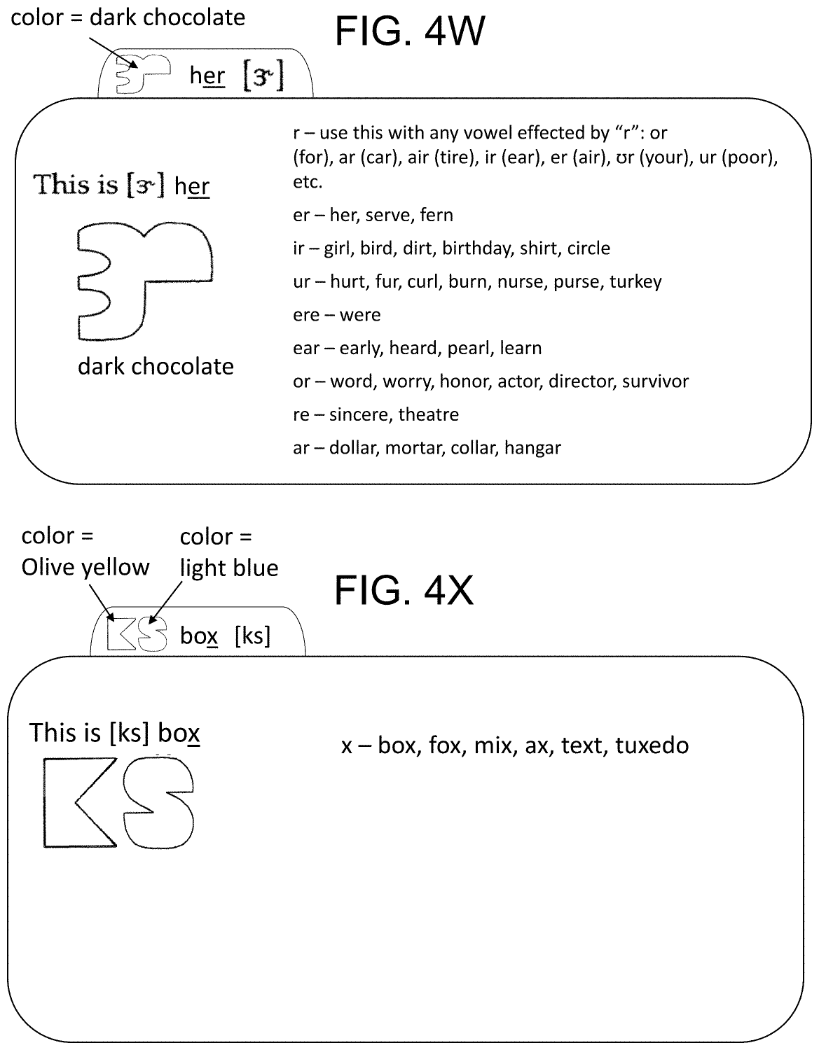

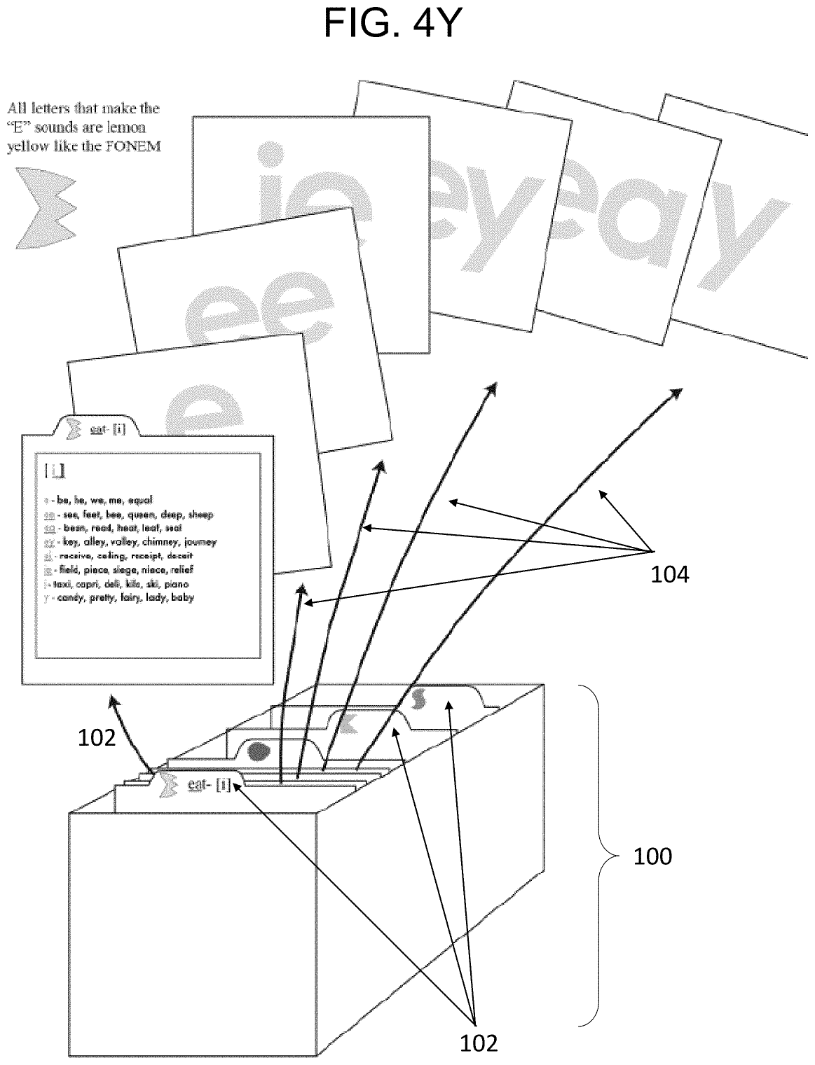

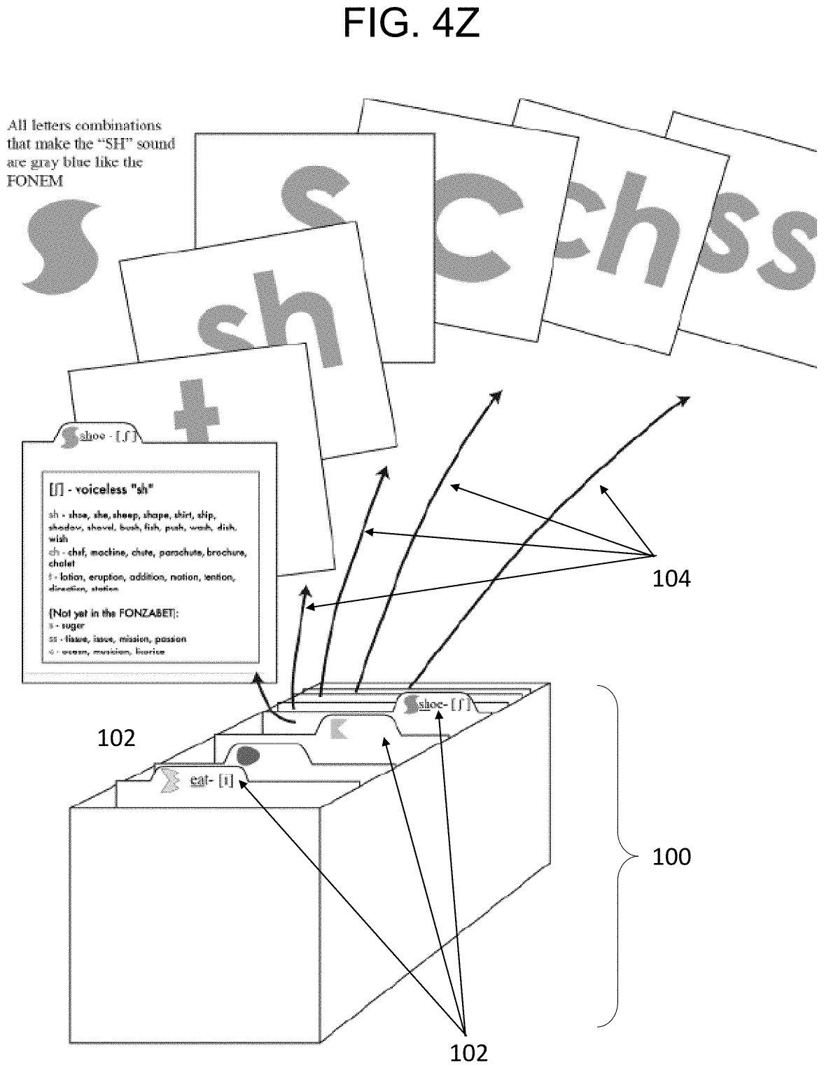

FIG. 3A illustrates the phoneme [Λ] from the International Phonetic Chart illustrated in FIG. 2A provided on an index divider card. This phoneme is pronounced like the vowel “u,” as used in the word “up.” In accordance with FIG. 1A of the related art, as disclosed in Applicant's U.S. Pat. No. 7,172,427, this phoneme [Λ] is represented by the color “camel” together with the shape [symbol] . FIG. 3A of the present inventive concept illustrates each of the possible letters and letter combinations that can have the sound of the phoneme [Λ]. As illustrated, these letters and letter combinations include u, a, o, e, io, i, ea, eo, ai and ou. As such, the present inventive concept provides an indicator card (FIG. 3A) showing these letters and letter combinations, together with applications of these letters and letter combinations used in words having the sound of the phoneme [Λ], thus helping individuals with hearing and/or speech impairments or other learning difficulties to pronounce these sounds and words correctly according to the American English language. An important part of the present inventive concept is the addition of a plurality of corresponding cards, each card of the plurality of cards including either one of the letters or one of the combination of letters that have the same sound as the phomene [Λ]. Each of the letters and combination of letters provided on a respective card have the same sound as the phoneme [Λ] are also provided in the same color as the color of the shape [symbol] representing the phomene [Λ]. More specifically, there is a card for each of the letters and combination of letters u, a, o, e, io, i, ea, eo, ai and ou. An example of a plurality of cards that are provided with a corresponding index card is illustrated in FIG. 4Y, where an index card for a phoneme [i] is illustrated together with a shape [symbol] , representing the phoneme [i] and provided in the color lemon, together with a card for each of the letters and combination of letters that make the sound of the phoneme [i]. Each of the letters and combination of letters on a respective card is also provided in the color lemon to correspond with the color of the shape [symbol] so that a student with hearing and/or speech impairments or other learning difficulties can match the color of the correct letter or combination of letters with the shape that represents the correct phoneme. For example, if a teacher is teaching a student to spell “up,” the student will first select the shape [symbol] , which is in the color camel, and then the student will be able to select a card with the letter “u” on it, which is also in the color camel, thus helping the student to correctly begin to spell the word “up.” Although this phenome [Λ] is represented by the color “camel” together with the shape [symbol] , also provided in the color camel in this exemplary embodiment, the phoneme [Λ] could alternatively be represented by another color and shape without departing from the principles and spirit of the present inventive concept, as long as this color remains unique to this phoneme shape [symbol] representing the phoneme [Λ]. In other words, each phoneme must have its own distinctive color and must always be depicted by that same color.

FIG. 3B illustrates the phoneme [j] from the International Phonetic Chart illustrated in FIG. 2A provided on an index divider card. This phoneme is pronounced with the vowel “y,” as used in the word “yes.” In accordance with FIG. 1A as disclosed in Applicant's U.S. Pat. No. 7,172,427, this phoneme [j] is represented by the color “mustard yellow” together with the shape [symbol] FIG. 3B of the present inventive concept illustrates each of the possible letters that can have the sound of the phoneme [j]. As illustrated, these letters include only the letter “y.” As such, the present inventive concept provides an indicator (index divider) card (FIG.3B) showing this letter “y” together with applications of this letter used in example words having the sound of the phoneme [j], thus helping individuals with hearing impairments and other speech difficulties to pronounce these sounds and words correctly according to the American English language. In addition to the index card illustrating the phoneme [j] from the International Phonetic Chart and the specifically colored shape [symbol] representing the phoneme [j] are a plurality of corresponding cards, each card of the corresponding cards including either one of the letters or one of the combination of letters that have the same sound as the phomene [j]. Each of the letter and combination of letters provided on a respective card that have the same sound as the phoneme [j] are also provided in the same color as the color of the shape [symbol] representing the phomene [j]. More specifically, there is a card for the letter y, which is the only letter that has the same sound as the phoneme [j]. As pointed out above, an example of a plurality of cards that are provided with a corresponding index card is illustrated in FIG. 4Y, where an index card for a phoneme [i] is illustrated together with a shape [symbol] representing the phoneme [j] in the color mustard yellow, together with a card for each of the letters and combinations of letters that make the sound of the phoneme [i], where each of the letters and combination of letters is also provided in the color lemon to correspond with the color of the shape. For example, in the case of the phenome [j], if a teacher is teaching a student to spell the word “yes,” the student will first select the shape [symbol] , which is presented in the color mustard yellow, and then the student will be able to select a card with the letter “y” on it, which is also in the color mustard yellow, thus helping the student to learn how to correctly begin to spell the word “yes.” The student will achieve success even if different letters of different colors are presented as choices.

FIG. 3C illustrates the phoneme [ [symbol] ] from the International Phonetic Chart illustrated in FIG. 2A provided on an index card. This phoneme is pronounced like the vowel “a,” as used in the word “at.” In accordance with FIG. 1A as disclosed in Applicant's U.S. Pat. No. 7,172,427, this phoneme [ [symbol] ] is represented by the color “rust” together with the shape [symbol] . FIG. 3C of the present inventive concept illustrates each of the possible letters and letter combinations that can have the sound of the phoneme [ [symbol] ]. As illustrated, the letter and letter combinations include a, ai and au. As such, the present inventive concept provides an indicator card (FIG. 3C) showing these letter and letter combinations, together with applications of these letter and letter combinations used in example words having the sound of the phoneme [ [symbol] ], thus helping individuals with hearing impairments and other speech difficulties to pronounce these sounds and words correctly according to the American English language. In addition to the index card dividers illustrating the phoneme [ [symbol] ] from the International Phonetic Chart and the specifically colored shape [symbol] representing the phoneme [ [symbol] ] are a plurality of corresponding index cards, each card of the plurality of index cards including either one of the letters or one of the combination of letters that have the same sound as the phoneme [ [symbol] ]. Each of the letter and combination of letters provided on a respective index card that have the same sound as the phoneme [ [symbol] ] are also provided in the same color as the color of the shape [symbol] representing the phoneme [ [symbol] ]. More specifically, there is a card for the letter “a” and a card for the combination of letters ai and au, which all have the same sound as the phoneme [ [symbol] ]. Thus, in the case of the phoneme [ [symbol] ], if a teacher is teaching a student to spell the word “apple,” the student will first select the shape [symbol] , which is in the color rust, and then the student will be able to select a card with the letter “a” on it, which is also in the color rust, thus helping the student to learn how to correctly begin to spell the word “yes.” The student will achieve success even if letters of different colors are presented as choices.

FIG. 3D illustrates the phoneme [I] from the International Phonetic Chart illustrated in FIG. 2A provided on an index card. This phoneme is pronounced like the vowel “i,” as used in the word “in.” In accordance with FIG. 1A of the related art as invented and by Applicant, this phoneme is represented by the color “yellow” together with the shape [symbol] . FIG. 3D of the present inventive concept illustrates each of the possible letters that can have the sound of the phoneme [I]. These letters include i and y. As such, the present inventive concept provides an indicator (index divider) card (FIG. 3D) showing these letters as well as sampling of applications in which these letters used in a sampling of words with the letter or letter combinations that make the sound of the phoneme [I]. In addition to the index card illustrating the phoneme [I] from the International Phonetic Chart and the specifically colored shape [symbol] (i.e., yellow) representing the phoneme [I] are a plurality of corresponding cards, each card of the plurality of cards including either one of the letters or one of the combination of letters that have the same sound as the phoneme [I]. Each of the letter and combination of letters provided on a respective card that have the same sound as the phoneme [I] are also provided in the same color yellow as the color of the shape [symbol] representing the phoneme [I]. More specifically, there is a corresponding card for the letter “i” and a card for the letter “y,” which each have the same sound as the phoneme [I]. Thus, in the case of the phoneme [I], if a teacher is teaching a student to spell the word “in,” the student will first select the shape [symbol] , which is in the color yellow, and then the student will be able to select a card with the letter “i” on it, which is also in the same color yellow, thus helping the student to learn how to correctly begin to spell the word “in.”

FIG. 3E illustrates the phoneme [ε] pronounced like the vowel “e,” as used in the word “bed.” In accordance with FIG. 1A as disclosed in Applicant's U.S. Pat. No. 7,172,427, this phoneme is represented by the color “fluorescent orange” and with the shape [symbol] also provided in the color fluorescent orange, both being provided on an index divider card representing the phoneme [ε]. FIG. 3E of the present inventive concept also illustrates each of the possible letters and letter combinations that can have the sound of the phoneme [ε]. These letters and letter combinations include e, ea and a. As such, the present inventive concept provides an indicator or index divider card (FIG. 3E) showing these letters and letter combination, as well as applications of these letters and letter combination used in words having the sound of the phoneme [ε]. In addition to the index divider card illustrating the phoneme [ε] from the International Phonetic Chart and the specifically colored shape [symbol] (i.e., fluorescent orange) representing the phoneme [ε] are a plurality of corresponding index cards, each card of the plurality of index cards including either one of the letters or one of the combination of letters that have the same sound as the phoneme [ε]. Each of the letter and combination of letters provided on a respective index card that have the same sound as the phoneme [ε] are also provided in the same color fluorescent orange as the color of the shape [symbol] representing the phoneme [ε]. More specifically, there is a corresponding card for the letter “e,” the letter “a,” and the combination of letters “ea,” each having the same sound as the phoneme [ε] and provided in the same color as the shape [symbol] (i.e., fluorescent orange). Thus, in the case of the phoneme [ε], if a teacher is teaching a student to spell the word “head,” after the teacher places the shapes representing h (see FIGS. 1C and 4D ( [symbol] ), ea ( [symbol] ), and d (see FIGS. 1D and 4O ( [symbol] )) in order, the student will be able to select the card having the letter “h” on it, which is provided in the same color as the shape [symbol] representing “h”, and then the student will be able to select the card having the combination of letters “ea” on it, which is provided in the same color as the shape [symbol] , which is in the color fluorescent orange, and then the student will be able to select a card with the letter “d” on it, which is in the same color as the shape [symbol] , thus helping the student to learn how to correctly spell the word “head.”

FIG. 3F illustrates the phoneme [i] pronounced like the combined vowels “ea,” as used in the word “eat.” In accordance with FIG. 1A as disclosed in Applicant's U.S. Pat. No. 7,172,427, this phoneme is represented by the color “lemon yellow” together with the shape [symbol] also provided in the color lemon yellow. FIG. 3F of the present inventive concept illustrates an index divider card having each of the possible letters and letter combinations that can have the sound of the phoneme [i] together with the phoneme [i] and the shape [symbol] , all provided in the color lemon yellow. These letters and letter combinations include e, ee, ea, ey, ei, ie, i, y. As such, the present inventive concept provides an indicator (or index divider) card (FIG. 3F) showing these letters and letter combinations, as well as sample words that show the application of the letter and letter combinations that make the sound of the phoneme [i], thus helping individuals with hearing impairments and other speech difficulties to pronounce these sounds and words correctly according to the American English language. In addition to the index divider card illustrating the phoneme [i], the shape [symbol] , and the letters and combination of letters that have the same sound as the phoneme [i] are a plurality of corresponding index cards, each index card of the plurality of index cards including either one of the letters or one of the combination of letters e, ee, ea, ey, ei, ie, i, y. Each of the letter and combination of letters provided on a respective index card that have the same sound as the phoneme [i] are also provided in the same color lemon yellow as the color of the shape [symbol] representing the phoneme [i]. Thus, in the case of the phoneme [i], if a teacher is teaching a student to spell the word “eat,” after the teacher presents the shape [symbol] representing the phoneme [i] to the student, the student will then be able to select from the index cards having the letters e, ee, ea, ey, ei, ie, i, y, thus helping the student to begin learning how to correctly spell the word “eat.” FIG. 4Y provides an additional view of how these index cards are organized in a file that contains all of the letter or letter combinations for each phoneme.

FIG. 3G illustrates the phoneme [eI] pronounced like the vowel “a,” as used in the word “day.” In accordance with FIG. 1A of the related art as invented by Applicant, this phoneme is represented by the color “yellow orange” together with the shape [symbol] . FIG. 3G of the present inventive concept illustrates each of the possible letters and letter combinations that can have the sound of the phoneme [eI], together with the phoneme [eI] and the shape [symbol] , all in the color yellow orange on an index card. These letters and letter combinations include a, a_e, ay, ai, ea, ei, eigh and ey. As such, the present inventive concept provides an indicator (or index divider) card (FIG. 3G) showing the letters and letter combinations, as well as sample words that show the application of the letters and letter combinations that make the sound of the phoneme [eI]. In addition to the index card illustrating the phoneme [eI], the shape [symbol] , and the letters and combination of letters that have the same sound as the phoneme [eI], are a plurality of corresponding cards, each card of the plurality of cards including either one of the letters or one of the combination of letters a, a_e, ay, ai, eigh or ey. Each of the letter and combination of letters provided on a respective card that have the same sound as the phoneme [eI] are also provided in the same color yellow orange as the color of the shape [symbol] representing the phoneme [eI], thus helping individuals with hearing and/or speech impairments or other speech difficulties to select the correct letter or combination of letters that are used to spell words including the sound of the phoneme [eI] therein.

FIG. 3H illustrates the phoneme [w] pronounced like the vowel “w,” as used in the word “with.” In accordance with FIG. 1A as disclosed in Applicant's U.S. Pat. No. 7,172,427, this phoneme is represented by the color “cream beige” together with the shape [symbol] . FIG. 3H of the present inventive concept illustrates each of the possible letters and letter combinations that can have the sound of the phoneme [w]. These letters and letter combinations include w, wh, u and o. As such, the present inventive concept provides an indicator (index divider) card (FIG. 3H) showing these letters and letter combination in the color cream beige, as well as sample words that show the application of the letters and letter combination that make the sound of the phoneme [w], together with the shape [symbol] and the phoneme [w] all in the color cream beige. In addition to the index card illustrating the phoneme [w], the shape [symbol] , and the letters and combination of letters that have the same sound as the phoneme [w], are a plurality of corresponding cards, each card of the plurality of cards including either one of the letters or one of the combination of letters w, wh, u and o. Each of the letter and combination of letters provided on a respective card that have the same sound as the phoneme [w] are also provided in the same color cream beige as the color of the shape [symbol] representing the phoneme [w], thus helping individuals with hearing and/or speech impairments or other speech difficulties to select the correct letter or combination of letters that are used to spell words including the sound of the phoneme [w] therein.

FIG. 3I illustrates the phoneme [α] pronounced like the vowel “o,” as used in the word “hot.” In accordance with FIG. 1A as disclosed in Applicant's U.S. Pat. No. 7,172,427, this phoneme is represented by the color “bright red” together with the shape [symbol] also in the color bright red. FIG. 3I of the present inventive concept also illustrates each of the possible letters and letter combinations that can have the sound of the phoneme [α], together with the phoneme [α] and the shape [symbol] , all in the color bright red, on an index divider card. These letters and letter combinations that can have the sound of the phoneme [α] include o, a, ou, augh, ough and aw. As such, the present inventive concept provides an indicator card (FIG. 3I) showing these letters and letter combinations, as well as sample words that show the application of the letters and letter combinations that make the sound of the phoneme [α], thus helping individuals with hearing impairments and other speech difficulties to pronounce these sounds and words correctly according to the American English language. In addition to the index card illustrating the phoneme [α], the shape [symbol] , and the letters and combination of letters that have the same sound as the phoneme [α], are a plurality of corresponding cards, each card of the plurality of cards including either one of the letters or one of the combination of letters o, a, ou, augh, ough and aw. Each of the letter and combination of letters provided on a respective card that have the same sound as the phoneme [α] are also provided in the same color bright red as the color of the shape [symbol] representing the phoneme [α], thus helping individuals with hearing and/or speech impairments or other speech difficulties to select the correct letter or combination of letters that are used to spell words including the sound of the phoneme [α] therein.

FIG. 3J illustrates the phoneme [ou] pronounced like the combination of vowels “oa,” as in the word “boat.” In accordance with FIG. 1A as disclosed in Applicant's U.S. Pat. No. 7,172,427, this phoneme is represented by the color “bright pink” together with the shape [symbol] . FIG. 3J of the present inventive concept also illustrates each of the possible letter and letter combinations that have the sound of the phoneme [ou], each being presented in the same color bright pink. These letter and letter combinations include o, oe, o_e, oa, ough, ow, ou and ew. As such, the present inventive concept provides an indicator (or index divider) card (FIG. 3J) showing these letter and letter combinations, as well as sample words that show the application of the letter and letter combinations that make the sound of the phoneme [ou]. In addition to the index divider card illustrating the phoneme [ou], the shape [symbol] , and the letters and combination of letters that have the same sound as the phoneme [ou], are a plurality of corresponding index cards, each index card of the plurality of index cards including either one of the letters or one of the combination of letters o, oe, o_e, oa, ough, ow, ou and ew. Each of the letter and combination of letters provided on a respective index card that have the same sound as the phoneme [ou] are also provided in the same color bright pink as the color of the shape [symbol] representing the phoneme [ou], thus helping individuals with hearing and/or speech impairments or other speech difficulties to select the correct letter or combination of letters that are used to spell words including the sound of the phoneme [ou] therein.

FIG. 3K illustrates the phoneme [ [symbol] ] pronounced like the vowels “o,” as used in the word “dog” Or “paw.” In accordance with FIG. 1A as disclosed in Applicant's U.S. Pat. No. 7,172,427, this phoneme is represented by the color “maroon” and with the shape [symbol] . FIG. 3K of the present inventive concept also illustrates each of the possible letters and letter combinations that can have the sound of the phoneme [ [symbol] ] each being presented in the same color maroon. These letters and letter combinations include aw, a, au, augh, o, ough, ou and oa. As such, the present inventive concept provides an indicator (index divider) card (FIG. 3K) showing these letters and letter combinations, as well as sample words that show the application of the letter and letter combinations that make the sound of the phoneme [ [symbol] ]. In addition to the index card illustrating the phoneme [ [symbol] ], the shape [symbol] , and the letters and combination of letters that have the same sound as the phoneme [ [symbol] ], are a plurality of corresponding cards, each card of the plurality of cards including either one of the letters or one of the combination of letters aw, a, au, augh, o, ough, ou and oa. Each of the letter and combination of letters provided on a respective card that have the same sound as the phoneme [ [symbol] ] are also provided in the same color maroon as the color of the shape [symbol] representing the phoneme [ [symbol] ], thus helping individuals with hearing and/or speech impairments or other speech difficulties to select the correct letter or combination of letters that are used to spell words including the sound of the phoneme [ [symbol] ] therein.

FIG. 3L illustrates the phoneme [oI] pronounced with the combination of vowels “oI,” as in the word “boy.” In accordance with FIG. 1A as disclosed in Applicant's U.S. Pat. No. 7,172,427, this phoneme is represented by the color “salmon” together with the shape [symbol] also provided in the same color salmon. FIG. 3L of the present inventive concept also illustrates each of the possible letter combinations that can have the sound of the phoneme [oI]. These letter combinations include oy and oi. As such, the present inventive concept provides an indicator card (FIG. 3L) showing these letter combinations as well as applications of these letter combinations used in words having the sound of the phoneme [oI], each in the same color salmon. In addition to the index card illustrating the phoneme [oI], the shape [symbol] , and the combination of letters that have the same sound as the phoneme [oI], are a plurality of corresponding cards, each card of the plurality of cards including one of the combination of letters oy and oi. Each of the combination of letters provided on a respective card that has the same sound as the phoneme [oI] are also provided in the same color salmon as the color of the shape [symbol] representing the phoneme [oI], thus helping individuals with hearing and/or speech impairments or other speech difficulties to select the correct letter or combination of letters that are used to spell words including the sound of the phoneme [oI] therein.

FIG. 3M illustrates the phoneme [αI] pronounced like the vowel “i,” as in the word “bike.” In accordance with FIG. 1A as disclosed in Applicant's U.S. Pat. No. 7,172,427, this phoneme is represented by the color “orange” together with the shape [symbol] also provided in the color orange. FIG. 3M of the present inventive concept also illustrates each of the possible letters and letter combinations that can have the sound of the phoneme [αI]. These letters and letter combinations include i, ie, i_e, y, ei, igh, ye and uy. As such, the present inventive concept provides an indicator (or index divider) card (FIG. 3M) showing these letters and letter combinations, in the color orange, as well as sample words that show the application of the letters and letter combinations that make the sound of the phoneme [αI]. In addition to the index divider card illustrating the phoneme [oI], the shape [symbol] , and the combination of letters that have the same sound as the phoneme [αI], are a plurality of corresponding index cards, each index card of the plurality of index cards including either one of the letters or one of the combination of letters i, ie, i_e, y, ei, igh, ye and uy. Each of the letters and combination of letters provided on a respective index card that has the same sound as the phoneme [αI] are also provided in the same color orange as the color of the shape [symbol] representing the phoneme [αI], thus helping individuals with hearing and/or speech impairments or other speech difficulties to select the correct letter or combination of letters that are used to spell words including the sound of the phoneme [αI] therein.

FIG. 3N illustrates the phoneme [ [symbol] ] pronounced like the combination of vowels “oo,” as in the word “foot.” In accordance with FIG. 1A as disclosed in Applicant's U.S. Pat. No. 7,172,427, this phoneme is represented by the color “shocking pink” together with the shape [symbol] also provided in the color shocking pink. FIG. 3N of the present inventive concept also illustrates each of the possible letters and letter combinations that can have the sound of the phoneme [ [symbol] ]. These letters and letter combinations include oo, ou and u. As such, the present inventive concept provides an indicator (or index divider) card (FIG. 3N) showing the letter and letter combinations in the color shocking pink, as well as sample words that show the application of the letter and letter combinations that make the sound of the phoneme [ [symbol] ]. In addition to the index divider card illustrating the phoneme [ [symbol] ], the shape [symbol] , and the combination of letters that have the same sound as the phoneme [ [symbol] ], are a plurality of corresponding ndex cards, each index card of the plurality of index cards including either one of the letters or one of the combination of letters oo, ou and u. Each of the letters and combination of letters provided on a respective index card that has the same sound as the phoneme [ [symbol] ] are also provided in the same color shocking pink as the color of the shape [symbol] representing the phoneme [ [symbol] ], thus helping individuals with hearing and/or speech impairments or other speech difficulties to select the correct letter or combination of letters that are used to spell words including the sound of the phoneme [ [symbol] ] therein.

FIG. 3O illustrates the phoneme [u] pronounced like the vowel “o,” as used in the word “who.” In accordance with FIG. 1A as disclosed in Applicant's U.S. Pat. No. 7,172,427, this phoneme [u] is represented by the color “pink” together with the shape [symbol] also provided in the color pink. FIG. 3O of the present inventive concept also illustrates each of the possible letter and letter combinations that can have the sound of the phoneme [u]. These letters and letter combinations include oo, u, ue, ew, iew, wo, ough, iu, oe, ioux, eau and ieu. As such, the present inventive concept provides an indicator (or index divider) card (FIG. 3O) showing these letters and letter combinations in the color pink, as well as sample words that show the application of the letter and letter combinations that make the sound of the phoneme [u]. In addition to the index divider card illustrating the phoneme [u], the shape [symbol] , and the combination of letters that have the same sound as the phoneme [u], are a plurality of corresponding index cards, each index card of the plurality of index cards including either one of the letters or one of the combination of letters oo, u, ue, ew, iew, wo, ough, iu, oe, ioux, eau and ieu. Each of the letters and combination of letters provided on a respective index card that has the same sound as the phoneme [ [symbol] ] are also provided in the same color pink as the color of the shape [symbol] representing the phoneme [u], thus helping individuals with hearing and/or speech impairments or other speech difficulties to select the correct letter or combination of letters that are used to spell words including the sound of the phoneme [u] therein.

FIG. 3P illustrates the phoneme [αu] pronounced like the combination of vowels “au,” as used in the word “ouch.” In accordance with FIG. 1A as disclosed in Applicant's U.S. Pat. No. 7,172,427, this phoneme [αu] is represented by the color “mauve” together with the shape [symbol] also provided in the color mauve. FIG. 3P of the present inventive concept also illustrates each of the possible letter combinations that can have the sound of the phoneme [αu]. These letter combinations include ow, ou, ough, hou and au. As such, the present inventive concept provides an indicator (or index divider) card (FIG. 3P) showing these letter combinations in the color mauve, as well as sample words that show the application of the letter combinations that make the sound of the phoneme [αu]. In addition to the index divider card illustrating the phoneme [αu], the shape [symbol] , and the combination of letters that have the same sound as the phoneme [αu], are a plurality of corresponding index cards, each index card of the plurality of index cards including one of the combination of letters ow, ou, ough, hou and au. Each of the combination of letters provided on a respective card that has the same sound as the phoneme [αu] are also provided in the same color mauve as the color of the shape [symbol] representing the phoneme [αu], thus helping individuals with hearing and/or speech impairments or other speech difficulties to select the correct letter or combination of letters that are used to spell words including the sound of the phoneme [αu] therein.

FIG. 3Q illustrates the letter [e], which is silent. This silent [e] is represented by the color “gray” together with the shape [symbol] . also provided in the color gray. FIG. 3Q of the present inventive concept also illustrates the single letter that is used for the silent [e]. The letter in this case is “e,” which is also provided in the color gray. FIG. 3Q also provides example of words in which the letter “e” is silent. In addition to the index divider card illustrating the silent letter [e], the shape [symbol] , and the letter that has the same silent sound as the letter [e], is an additional index card having the letter “e” on it, also provided in the same color gray, thus helping individuals with hearing and/or speech impairments or other speech difficulties to select the correct letter that is used to spell words including the silent sound of the letter [e] therein.

It is to be noted that although a specific color and specific shape in accordance the examplary embodiment illustrated in FIGS. 3A throught 3P is used to represent each of the vowel phonemes listed in the International Phonetic Alphabet illustrated in FIG. 2A, each of these vowel phonemes could be represented by another color and/or shape without departing from the principles and spirit of the present inventive concept.

FIG. 4A illustrates the phoneme [p] pronounced like the consonant “p” as used in the word “pie.” In accordance with FIG. 1C as disclosed in Applicant's U.S. Pat. No. 7,172,427, this phoneme [p] is represented by the color “lime green” together with the shape [symbol] also provided in the color lime green. FIG. 4A of the present inventive concept also illustrates each of the possible letters and letter combinations that can have the sound of the phoneme [p]. The letter and letter combinations include p and pp. As such, the present inventive concept provides an indicator (or index divider) card (see FIG. 4A) showing these letter and letter combinations, also in the same color lime green, as well as sample words that show the application of the letter and letter combinations that make the sound of the phoneme [p]. In addition to the index divider card illustrating the phoneme [p], the shape [symbol] , and the combination of letters p and pp that have the same sound as the phoneme [p], are a plurality of corresponding index cards, each card of the plurality of index cards including one of the combination of letters p and pp. Each of the combination of letters provided on a respective card that has the same sound as the phoneme [p] are also provided in the same color lime green as the color of the shape [symbol] representing the phoneme [p], thus helping individuals with hearing and/or speech impairments or other speech difficulties to select the correct letter or combination of letters that are used to spell words including the sound of the phoneme [p] therein.

FIG. 4B illustrates the phoneme [b] pronounced like the consonant “b” as used in the word “box.” In accordance with FIG. 1C as disclosed in Applicant's U.S. Pat. No. 7,172,427, this phoneme [b] is represented by the color “green” together with the shape [symbol] also provided in the same color green. FIG. 4B of the present inventive concept also illustrates each of the possible letter and letter combinations that can have the sound of the phoneme [b]. The letter and letter combination include b and bb, also provided in the same color green. As such, the present inventive concept provides an indicator (or index divider) card (see FIG. 4B) showing the letter and letter combination, in the color green, as well as sample words that show the application of the letter and letter combination that make the sound of the phoneme [b]. In addition to the index divider card illustrating the phoneme [b], the shape [symbol] , and the letter or combination of letters b and bb that have the same sound as the phoneme [b], are a plurality of corresponding index cards, each card of the plurality of index cards including either the letter b or one the combination of letters bb. Each of the letter or combination of letters provided on a respective card that has the same sound as the phoneme [b] are also provided in the same color lime green as the color of the shape [symbol] representing the phoneme [b], thus helping individuals with hearing and/or speech impairments or other speech difficulties to select the correct letter or combination of letters that are used to spell words including the sound of the phoneme [b] therein.

FIG. 4C illustrates the phoneme [m] pronounced like the consonant “m” as used in the word “mom.” In accordance with FIG. 1C as disclosed in Applicant's U.S. Pat. No. 7,172,427, this phoneme [m] is represented by the color “royal blue” together with the shape [symbol] also provided in the color royal blue. FIG. 4C of the present inventive concept also illustrates each of the possible letters and letter combinations that can have the sound of the phoneme [m]. These letters and letter combinations include m, mb and mm. As such, the present inventive concept provides an indicator (or index divider) card (see FIG. 4C) showing the letter and letter combinations in the color royal blue, as well as sample words that show the application of the letter and letter combinations that make the sound of the phoneme [m]. In addition to the index divider card illustrating the phoneme [m], the shape [symbol] , and the letters or combination of letters m, mb and mm that have the same sound as the phoneme [m], are a plurality of corresponding index cards, each card of the plurality of index cards including one of the letters or combination of letters m, mb and mm. Each of the letters and combination of letters provided on a respective card that have the same sound as the phoneme [m] are also provided in the same color royal blue as the color of the shape [symbol] representing the phoneme [m], thus helping individuals with hearing and/or speech impairments or other speech difficulties to select the correct letter or combination of letters that are used to spell words including the sound of the phoneme [m] therein.

FIG. 4D illustrates the phoneme [h] pronounced like the consonant “h” as used in the word “hat.” In accordance with FIG. 1C as disclosed in Applicant's U.S. Pat. No. 7,172,427, this phoneme [h] is represented by the color “white” together with the shape [symbol] also provided in the color white. FIG. 4D of the present inventive concept also illustrates each of the possible letters and letter combinations that can have the sound of the phoneme [h]. The letter and letter combination include h and wh. As such, the present inventive concept provides an indicator (or index divider) card (see FIG. 4D) showing the letter and letter combination, also in the color white, as well as sample words that show the application of the letter and letter combination that make the sound of the phoneme [h]. In addition to the index divider card illustrating the phoneme [h], the shape [symbol] , and the letters or combination of letters h and wh that have the same sound as the phoneme [h], are a plurality of corresponding index cards, each card of the plurality of index cards including one of the letters or combination of letters h and wh. Each of the letters and combination of letters provided on a respective card that have the same sound as the phoneme [h] are also provided in the same color white as the color of the shape [symbol] representing the phoneme [h], thus helping individuals with hearing and/or speech impairments or other speech difficulties to select the correct letter or combination of letters that are used to spell words including the sound of the phoneme [h] therein.

FIG. 4E illustrates the phoneme [f] pronounced like the consonant “f” as used in the word “fan.” In accordance with FIG. 1C as disclosed in Applicant's U.S. Pat. No. 7,172,427, this phoneme [f] is represented by the color “light violet” together with the shape [symbol] also provided in the color light violet. FIG. 4E of the present inventive concept also illustrates each of the possible letter and letter combinations that can have the sound of the phoneme [f]. The letter and letter combinations include f, ff, ph and gh. As such, the present inventive concept provides an indicator (or index divider) card (see FIG. 4E) showing the letter and letter combinations, also provided in the color light violet, as well sample words that show the application of the letter and letter combinations used in words having the sound of the phoneme [f]. In addition to the index divider card illustrating the phoneme [f], the shape [symbol] , and the letters or combination of letters f, ff, ph and gh that have the same sound as the phoneme [f], are a plurality of corresponding index cards, each card of the plurality of index cards including one of the letters or combination of letters f, ff, ph and gh. Each of the letters and combination of letters provided on a respective card that have the same sound as the phoneme [f] are also provided in the same color light violet as the color of the shape [symbol] representing the phoneme [f], thus helping individuals with hearing and/or speech impairments or other speech difficulties to select the correct letter or combination of letters that are used to spell words including the sound of the phoneme [f] therein.

FIG. 4F illustrates the phoneme [v] pronounced like the consonant “v” as used in the word “van.” In accordance with FIG. 1C of the related art as invented by Applicant, this phoneme [v] is represented by the color “purple” together with the shape [symbol] also provided in the same color purple. FIG. 4F of the present inventive concept illustrates each of the possible letters that can have the sound of the phoneme [v]. These letters include v. As such, the present inventive concept provides an indicator (or index divider) card (see FIG. 4F) showing this letter in the same color purple, as well as sample words that show the application of the letter that make the sound of the phoneme [v]. In addition to the index divider card illustrating the phoneme [v], the shape [symbol] , and the letter v that has the same sound as the phoneme [v], is a separate index card including the letter v provided in the same color purple as the color of the shape [symbol] representing the phoneme [v], thus helping individuals with hearing and/or speech impairments or other speech difficulties to select the correct letter or combination of letters that are used to spell words including the sound of the phoneme [v] therein.

FIG. 4G illustrates the phoneme [k] pronounced like the consonant “k” as used in the word “cow.” In accordance with FIG. 1C as disclosed in Applicant's U.S. Pat. No. 7,172,427, this phoneme [k] is represented by the color “olive yellow” together with the shape [symbol] also provided in the same color olive yellow. FIG. 4G of the present inventive concept also illustrates each of the possible letters and letter combinations that can have the sound of the phoneme [k]. These letters and letter combinations include c, k, ck, ch, cc and q. As such, the present inventive concept provides an indicator (or index divider) card (see FIG. 4G) showing these letters and letter combinations in the same color olive yellow, as well as sample words that show the application of the letters and letter combinations that make the sound of the phoneme [k]. In addition to the index divider card illustrating the phoneme [k], the shape [symbol] , and the letters or combination of letters c, k, ck, ch, cc and q that have the same sound as the phoneme [k], are a plurality of corresponding index cards, each index card of the plurality of index cards including one of the letters or combination of letters c, k, ck, ch, cc and q. Each of the letters and combination of letters provided on a respective index card that have the same sound as the phoneme [k] are also provided in the same color olive yellow as the color of the shape [symbol] representing the phoneme [k], thus helping individuals with hearing and/or speech impairments or other speech difficulties to select the correct letter or combination of letters that are used to spell words including the sound of the phoneme [k] therein.

FIG. 4H illustrates the phoneme [g] pronounced like the consonant “g” as used in the word “goat.” In accordance with FIG. 1C as disclosed in Applicant's U.S. Pat. No. 7,172,427, this phoneme [g] is represented by the color “olive green” together with the shape [symbol] also provided in the same color olive green. FIG. 4H of the present inventive concept illustrates each of the possible letters and letter combinations that can have the sound of the phoneme [g]. These letter and letter combinations include g, gg, gh and gue. As such, the present inventive concept provides an indicator (or index divider) card (see FIG. 4H) showing the letter and letter combinations in the same color olive green, as well as sample words that show the application of the letter and letter combinations that make the sound of the phoneme [g]. In addition to the index divider card illustrating the phoneme [g], the shape [symbol] , and the letters or combination of letters g, gg, gh and gue that have the same sound as the phoneme [g], are a plurality of corresponding index cards, each card of the plurality of index cards including one of the letters or combination of letters g, gg, gh and gue. Each of the letters and combination of letters provided on a respective index card that have the same sound as the phoneme [g] are also provided in the same color olive yellow as the color of the shape [symbol] representing the phoneme [g], thus helping individuals with hearing and/or speech impairments or other speech difficulties to select the correct letter or combination of letters that are used to spell words including the sound of the phoneme [g] therein.

FIG. 4I illustrates the phoneme [l] pronounced like the consonant “l” as used in the word “low.” In accordance with FIG. 1D as disclosed in Applicant's U.S. Pat. No. 7,172,427, this phoneme [l] is represented by the color “mocha brown” together with the shape [symbol] also provided in the same color mocha brown. FIG. 4I of the present inventive concept illustrates each of the possible letters and letter combinations that can have the sound of the phoneme [l]. These letter and letter combinations include l and ll. As such, the present inventive concept provides an indicator (or index divider) card (see FIG. 4I) showing the letter and letter combination in the same color mocha brown, as well as sample words that show the application of the letter and letter combination that make the sound of the phoneme [l]. In addition to the index divider card illustrating the phoneme [l], the shape [symbol] , and the letters or combination of letters l and ll that have the same sound as the phoneme [l], are a plurality of corresponding index cards, each card of the plurality of index cards including one of the letters or combination of letters l and ll. Each of the letters and combination of letters provided on a respective index card that have the same sound as the phoneme [l] are also provided in the same color mocha brown as the color of the shape [symbol] representing the phoneme [l], thus helping individuals with hearing and/or speech impairments or other speech difficulties to select the correct letter or combination of letters that are used to spell words including the sound of the phoneme [l] therein.

FIG. 4J illustrates the phoneme [n] pronounced like the consonant “n” as used in the word “no.” In accordance with FIG. 1D as disclosed in Applicant's U.S. Pat. No. 7,172,427, this phoneme [n] is represented by the color “bright blue” together with the shape [symbol] also provided in the same color bright blue. FIG. 4J of the present inventive concept also illustrates each of the possible letter and letter combinations that can have the sound of the phoneme [n]. The letter and letter combinations include n, kn, gn and nn. As such, the present inventive concept provides an indicator (or index divider) card (see FIG. 4I) showing the letter and letter combinations in the same color bright blue, as well as sample words that show the application of the letter and letter combinations used in words having the sound of the phoneme [n]. In addition to the index divider card illustrating the phoneme [n], the shape [symbol] , and the letters or combination of letters n, kn, gn and nn that have the same sound as the phoneme [n], are a plurality of corresponding index cards, each card of the plurality of index cards including one of the letters or combination of letters n, kn, gn and nn. Each of the letters and combination of letters provided on a respective index card that have the same sound as the phoneme [n] are also provided in the same color bright blue as the color of the shape [symbol] representing the phoneme [n], thus helping individuals with hearing and/or speech impairments or other speech difficulties to select the correct letter or combination of letters that are used to spell words including the sound of the phoneme [n] therein.

FIG. 4K illustrates the phoneme [ [symbol] ] pronounced like the sound of the combined consonants as used in the word “sing.” In accordance with FIG. 1D as disclosed in Applicant's U.S. Pat. No. 7,172,427, this phoneme [ [symbol] ] is represented by the color “dark turquoise” together with the shape [symbol] also provided in the same color dark turquoise. FIG. 4K of the present inventive concept also illustrates each of the possible letter and letter combinations that can have the sound of the phoneme [ [symbol] ]. The letter and letter combinations include ng and n. As such, the present inventive concept provides an indicator (or index divider) card (see FIG. 4K) showing the letter and letter combination in the same color dark turquoise, as well as sample words that show the application of the letter and letter combination used in words having the sound of the phoneme [ [symbol] ]. In addition to the index divider card illustrating the phoneme [ [symbol] ], the shape [symbol] , and the letters or combination of letters ng and n that have the same sound as the phoneme [ [symbol] ], are a plurality of corresponding index cards, each card of the plurality of index cards including one of the letters or combination of letters ng and n. Each of the letters and combination of letters provided on a respective index card that have the same sound as the phoneme [ [symbol] ] are also provided in the same color dark turquoise as the color of the shape [symbol] representing the phoneme [ [symbol] ], thus helping individuals with hearing and/or speech impairments or other speech difficulties to select the correct letter or combination of letters that are used to spell words including the sound of the phoneme [ [symbol] ] therein.

FIG. 4L illustrates the phoneme [⊖] pronounced like the combination of consonants “th” as used in the word “thin.” In accordance with FIG. 1D as disclosed in Applicant's U.S. Pat. No. 7,172,427, this phoneme [e] is represented by the color “light lavender” together with the shape [symbol] also provided in the same color light lavender. FIG. 4L of the present inventive concept also illustrates each of the possible letter and letter combinations that can have the sound of the phoneme [⊖]. The letter combinations include th. As such, the present inventive concept provides an indicator (or index divider) card (see FIG. 4L) showing the letter combination also in the same color light lavender, as well as sample words that show the application of the letter combination used in words having the sound of the phoneme [⊖]. In addition to the index divider card illustrating the phoneme [⊖], the shape [symbol] , and the combination of letters “th” that have the same sound as the phoneme [⊖], is a corresponding index card including the combination of letters “th.” The combination of letters provided on the corresponding index card that has the same sound as the phoneme [⊖] is also provided in the same color light lavender as the color of the shape [symbol] representing the phoneme [⊖], thus helping individuals with hearing and/or speech impairments or other speech difficulties to select the correct letter or combination of letters that are used to spell words including the sound of the phoneme [⊖] therein.

FIG. 4M illustrates the phoneme [ð] pronounced like the combined consonants “th” as used in the word “that.” In accordance with FIG. 1D as disclosed in Applicant's U.S. Pat. No. 7,172,427, this phoneme [ð] is represented by the color “violet” together with the shape [symbol] also provided in the same color violet. FIG. 4M of the present inventive concept also illustrates each of the possible letter combinations that can have the sound of the phoneme [ð]. The letter combinations include “th.” As such, the present inventive concept provides an indicator (or index divider) card (see FIG. 4M) showing the letter combination in the same color violet, as well as sample words that show the application of the letter combination used in words having the sound of the phoneme [ð] in American English words. In addition to the index divider card illustrating the phoneme [ð], the shape [symbol] , and the combination of letters “th” that have the same sound as the phoneme [ð], is a corresponding index card including the combination of letters “th.” The combination of letters provided on the corresponding index card that has the same sound as the phoneme [ð] is also provided in the same color violet as the color of the shape [symbol] representing the phoneme [ð], thus helping individuals with hearing and/or speech impairments or other speech difficulties to select the correct letter or combination of letters that are used to spell words including the sound of the phoneme [ð] therein.

FIG. 4N illustrates the phoneme [t] pronounced like the consonant “t” as used in the word “top.” In accordance with FIG. 1D as disclosed in Applicant's U.S. Pat. No. 7,172,427, this phoneme [t] is represented by the color “light turquoise” together with the shape [symbol] also provided in the same color light turquoise. FIG. 4N of the present inventive concept also illustrates each of the possible letter and letter combinations that can have the sound of the phoneme [t]. The letter and letter combinations include t, tt and ed. As such, the present inventive concept provides an indicator (or index divider) card (see FIG. 4N) showing the letter and letter combinations in the same color light turquoise, as well as sample words that show the application of the letter and letter combinations that make the sound of the phoneme [t]. In addition to the index divider card illustrating the phoneme [t], the shape [symbol] , and the letters or combination of letters t, tt and ed that have the same sound as the phoneme [t], are a plurality of corresponding index cards, each card of the plurality of index cards including one of the letters or combination of letters t, tt and ed. Each of the letters and combination of letters provided on a respective index card that have the same sound as the phoneme [t] are also provided in the same color light turquoise as the color of the shape [symbol] representing the phoneme [t], thus helping individuals with hearing and/or speech impairments or other speech difficulties to select the correct letter or combination of letters that are used to spell words including the sound of the phoneme [t] therein.

FIG. 4O illustrates the phoneme [d] pronounced like the consonant “d” as used in the word “dog.” In accordance with FIG. 1D as disclosed in Applicant's U.S. Pat. No. 7,172,427, this phoneme [d] is represented by the color “turquoise” together with the shape [symbol] also provided in the same color turquoise. FIG. 4O of the present inventive concept also illustrates each of the possible letter and letter combinations that can have the sound of the phoneme [d]. The letter and letter combinations include d, dd and ed. As such, the present inventive concept provides an indicator (or index divider) card (see FIG. 4O) showing the letter and letter combinations in the same color turquoise, as well as sample words that show the application of the letter and letter combinations used in words having the sound of the phoneme [d]. In addition to the index divider card illustrating the phoneme [d], the shape [symbol] and the letters or combination of letters d, dd and ed that have the same sound as the phoneme [d], are a plurality of corresponding index cards, each card of the plurality of index cards including one of the letters or combination of letters d, dd and ed. Each of the letters and combination of letters provided on a respective index card that have the same sound as the phoneme [d] are also provided in the same color turquoise as the color of the shape [symbol] representing the phoneme [d], thus helping individuals with hearing and/or speech impairments or other speech difficulties to select the correct letter or combination of letters that are used to spell words including the sound of the phoneme [d] therein.

FIG. 4P illustrates the phoneme [s] pronounced like the consonant “s” as used in the word “sun.” In accordance with FIG. 1E of the related art as invented by Applicant, this phoneme [s] is represented by the color “light blue” together with the shape [symbol] also provided in the same color light blue. FIG. 4P of the present inventive concept also illustrates each of the possible letter and letter combinations that can have the sound of the phoneme [s]. The letter and letter combinations include s, c, sc, ss and ps. As such, the present inventive concept provides an indicator (or index divider) card (see FIG. 4P) showing the letter and letter combinations in the same color light blue, as well as sample words that show the application of the letter and letter combinations used in words having the sound of the phoneme [s]. In addition to the index divider card illustrating the phoneme [s], the shape [symbol] , and the letters or combination of letters s, c, sc, ss and ps that have the same sound as the phoneme [s], are a plurality of corresponding index cards, each card of the plurality of index cards including one of the letters or combination of letters s, c, sc, ss and ps. Each of the letters and combination of letters provided on a respective index card that have the same sound as the phoneme [s] are also provided in the same color light blue as the color of the shape [symbol] representing the phoneme [s], thus helping individuals with hearing and/or speech impairments or other speech difficulties to select the correct letter or combination of letters that are used to spell words including the sound of the phoneme [s] therein.

FIG. 4Q illustrates the phoneme [z] pronounced like the consonant “z” as used in the word “zoo.” In accordance with FIG. 1E as disclosed in Applicant's U.S. Pat. No. 7,172,427, this phoneme [z] is represented by the color “blue” together with the shape [symbol] also provided in the same color blue. FIG. 4Q of the present inventive concept also illustrates each of the possible letters and letter combinations that can have the sound of the phoneme [z]. The letters and letter combinations include s, z, zz, ts/cz and x. As such, the present inventive concept provides an indicator (or index divider) card (see FIG. 4Q) showing the letters and letter combinations in the same color blue, as well as sample words that show the application of the letter and letter combinations used in words having the sound of the phoneme [z]. In addition to the index divider card illustrating the phoneme [z], the shape [symbol] , and the letters or combination of letters s s, z, zz, ts/cz and x that have the same sound as the phoneme [z], are a plurality of corresponding index cards, each card of the plurality of cards including one of the letters or combination of letters s, z, zz, ts/cz and x. Each of the letters and combination of letters provided on a respective index card that have the same sound as the phoneme [z] are also provided in the same color blue as the color of the shape [symbol] representing the phoneme [z], thus helping individuals with hearing and/or speech impairments or other speech difficulties to select the correct letter or combination of letters that are used to spell words including the sound of the phoneme [z] therein.

FIG. 4R illustrates the phoneme [ [symbol] ] pronounced like the combination of consonants “sh” as used in the word “shoe.” In accordance with FIG. 1E as disclosed in Applicant's U.S. Pat. No. 7,172,427, this phoneme [ [symbol] ] is represented by the color “gray blue” together with the shape [symbol] also provided in the same color gray blue. FIG. 4R of the present inventive concept also illustrates each of the possible letters and letter combinations that can have the sound of the phoneme [ [symbol] ]. The letters and letter combinations include sh, ch, t, s, ss and c. As such, the present inventive concept provides an indicator (or index divider) card (see FIG. 4R) showing the letters and letter combinations in the same color gray blue, as well as sample words that show the application of the letters and letter combinations used in words having the sound of the phoneme [ [symbol] ]. In addition to the index divider card illustrating the phoneme [ [symbol] ], the shape [symbol] , and the letters or combination of letters sh, ch, t, s, ss and c that have the same sound as the phoneme [ [symbol] ], are a plurality of corresponding index cards, each card of the plurality of index cards including one of the letters or combination of letters sh, ch, t, s, ss and c. Each of the letters and combination of letters provided on a respective index card that have the same sound as the phoneme [ [symbol] ] are also provided in the same color grey blue as the color of the shape [symbol] representing the phoneme [ [symbol] ], thus helping individuals with hearing and/or speech impairments or other speech difficulties to select the correct letter or combination of letters that are used to spell words including the sound of the phoneme [ [symbol] ] therein.

FIG. 4S illustrates the phoneme [3] pronounced like the combination of letters g and e as used in the word “rouge.” In accordance with FIG. 1E as disclosed in Applicant's U.S. Pat. No. 7,172,427, this phoneme [3] is represented by the color “dark wedgewood blue” together with the shape [symbol] also provided in the same color dark wedgewood blue. FIG. 4S of the present inventive concept also illustrates each of the possible letters that can have the sound of the phoneme [3]. The letters include s, z, and g. As such, the present inventive concept provides an indicator (or index divider) card (see FIG. 4S) showing the letters as well as sample words that show the application of letters that make the sound of the phoneme [3]. In addition to the index divider card illustrating the phoneme [3], the shape [symbol] , and the letters s, z, and g that have the same sound as the phoneme [3], are a plurality of corresponding index cards, each card of the plurality of index cards including one of the letters s, z, and g. Each of the letters provided on a respective index card that have the same sound as the phoneme [3] are also provided in the same color “dark wedgewood blue” as the color of the shape [symbol] representing the phoneme [3], thus helping individuals with hearing and/or speech impairments or other speech difficulties to select the correct letter or combination of letters that are used to spell words including the sound of the phoneme [3] therein.

FIG. 4T illustrates the phoneme [ [symbol] ] pronounced like the combination of consonants “ch” as used in the word “chick.” In accordance with FIG. 1E as disclosed in Applicant's U.S. Pat. No. 7,172,427, this phoneme [ [symbol] ] is represented by the color “jade” together with the shape [symbol] also provided in the same color jade. FIG. 4T of the present inventive concept also illustrates each of the possible letter combinations that can have the sound of the phoneme [ [symbol] ]. The letters combinations include ch and tch. As such, the present inventive concept provides an indicator (or index divider) card (see FIG. 4T) showing the letter combinations in the same color jade, as well as sample words that show the application of the letter combinations that make the sound of the phoneme [ [symbol] ]. In addition to the index divider card illustrating the phoneme [ [symbol] ], the shape [symbol] , and the combination of letters ch and tch that have the same sound as the phoneme [ [symbol] ], are a plurality of corresponding index cards, each card of the plurality of index cards including one of the combination of letters ch and tch. Each of the combination of letters provided on a respective index card that have the same sound as the phoneme [ [symbol] ] are also provided in the same color “jade” as the color of the shape [symbol] representing the phoneme [ [symbol] ], thus helping individuals with hearing and/or speech impairments or other speech difficulties to select the correct letter or combination of letters that are used to spell words including the sound of the phoneme [ [symbol] ] therein.

FIG. 4U illustrates the phoneme [ [symbol] ] pronounced like the consonant “j” as used in the word “jump.” In accordance with FIG. 1E of the related art as invented by Applicant, this phoneme [ [symbol] ] is represented by the color “forest green” together with the shape [symbol] also provided in the same color forest green. FIG. 4U of the present inventive concept illustrates each of the possible letter and letter combinations that can have the sound of the phoneme [ [symbol] ]. The letters and letter combinations include j, g, gg and dg. As such, the present inventive concept also provides an indicator (or index divider) card (see FIG. 4U) showing the letters and letter combinations in the same color “forest green,” as well as sample words that show the application of the letters and letter combinations that make the sound of the phoneme [ [symbol] ]. In addition to the index divider card illustrating the phoneme [ [symbol] ], the shape [symbol] , and the combination of letters j, g, gg and dg that have the same sound as the phoneme [ [symbol] ], are a plurality of corresponding index cards, each card of the plurality of index cards including one of the letters or the combination of letters j, g, gg and dg. Each of the letters and combination of letters provided on a respective index card that have the same sound as the phoneme [ [symbol] ] are also provided in the same color “forest green” as the color of the shape [symbol] representing the phoneme [ [symbol] ], thus helping individuals with hearing and/or speech impairments or other speech difficulties to select the correct letter or combination of letters that are used to spell words including the sound of the phoneme [ [symbol] ] therein.

FIG. 4V illustrates the phoneme [r] pronounced like the consonant “r” as used in the word “run.” In accordance with FIG. 1E as disclosed in Applicant's U.S. Pat. No. 7,172,427, this phoneme [r] is represented by the color “cocoa” together with the shape [symbol] also provided in the color “cocoa.” FIG. 4V of the present inventive concept also illustrates each of the possible letter and letter combinations that can have the sound of the phoneme [r]. The letter and letter combinations include r, rh, wr and rr. As such, the present inventive concept provides an indicator (or index divider) card (see FIG. 4V) showing the letter and letter combinations in the color “cocoa,” as well as sample words that show the application of the letter and letter combinations used in words having the sound of the phoneme [r]. In addition to the index divider card illustrating the phoneme [r], the shape [symbol] , and the letter r and the combination of letters rh, wr and rr that have the same sound as the phoneme [r], are a plurality of corresponding index cards, each card of the plurality of index cards including one of the letters or the combination of letters r, rh, wr and rr. Each of the letters and combination of letters provided on a respective index card that have the same sound as the phoneme [r] are also provided in the same color “cocoa” as the color of the shape [symbol] representing the phoneme [r], thus helping individuals with hearing and/or speech impairments or other speech difficulties to select the correct letter or combination of letters that are used to spell words including the sound of the phoneme [r] therein.

FIG. 4W illustrates the phoneme [ [symbol] ] pronounced like the combined letters “er” as used in the word “her.” In accordance with FIG. 1E as disclosed in Applicant's U.S. Pat. No. 7,172,427, this phoneme [ [symbol] ] is represented by the color “dark chocolate” together with the shape [symbol] also provided in the color “dark chocolate.” FIG. 4W of the present inventive concept also illustrates each of the possible letter and letter combinations that can have the sound of the phoneme [ [symbol] ]. The letter and letter combinations include r, er, ir, ur, ere, ear, or, re and ar. As such, the present inventive concept provides an indicator (or index divider) card (see FIG. 4W) showing the letter and letter combinations in the same color “dark chocolate,” as well as sample words that show the application of the letter and letter combinations that make the sound of the phoneme [ [symbol] ]. In addition to the index divider card illustrating the phoneme [ [symbol] ], the shape [symbol] , and the letter r and combination of letters er, ir, ur, ere, ear, or, re and ar that have the same sound as the phoneme [ [symbol] ], are a plurality of corresponding index cards, each card of the plurality of index cards including one of the letters or one of the combination of letters r, er, ir, ur, ere, ear, or, re and ar. Each of the letters and combination of letters provided on a respective index card that have the same sound as the phoneme [ [symbol] ] are also provided in the same color “dark chocolate” as the color of the shape [symbol] representing the phoneme [ [symbol] ], thus helping individuals with hearing and/or speech impairments or other speech difficulties to select the correct letter or combination of letters that are used to spell words including the sound of the phoneme [ [symbol] ] therein.

FIG. 4X illustrates the phoneme [ks] pronounced like the consonant “x” as used in the word “box.” In accordance with FIG. 4X, this phoneme [ks] is represented by the combination of colors “olive yellow” and “light blue” together with the shapes [symbol] . More specifically, the shape [symbol] is provided in olive yellow and the shape [symbol] is provided in light blue. FIG. 4X of the present inventive concept also illustrates each of the letters that can have the sound of the phoneme [ks]. The letters include x. As such, the present inventive concept provides an indicator (or index divider) card (see FIG. 4X) showing the letter in the same combination of colors “olive yellow” and “light blue,” as well as sample words that show the application of the letter used in words having the sound of the phoneme [ks]. In addition to the index divider card illustrating the phoneme [ks], the shapes [symbol] , and the letter x that has the same sound as the phoneme [ks], is a corresponding index card including the letter x in the same combination of colors “olive yellow” and “light blue” as the colors of the shapes [symbol] representing the phoneme [ks], thus helping individuals with hearing and/or speech impairments or other speech difficulties to select the correct letter or combination of letters that are used to spell words including the sound of the phoneme [ks] therein.

FIG. 4Y illustrates an example of the system 100 for teaching individuals with hearing disabilities and/or speech impairments, according to the present inventive concept. More specifically, FIG. 4Y illustrates a file system 100 including a portion of the entire set of index divider cards 102 and subsequent set of letter and letter combination cards 104 arranged in a file container 100 that make up the entire set of 40 phonemes. Each index divider card 102 illustrating one of the forty-four phonemes of the American English Language together with a specific shape and color (FONEMZ™), which was previously created in Applicant's earlier U.S. Pat. No. 7,172,427 to represent the respective phoneme. Also provided is a plurality of sets of index cards 104, each set of index cards being associated with a corresponding index divider card 102. Each index card 104 of the corresponding set of index cards 104 providing one of the letter(s) or combination(s) of letters that have the same sound as the corresponding phoneme [i]. For example, the index card 102 for the phoneme [i], which is pulled out of the set 100 for illustration purposes, includes the phoneme [i] in an upper tab thereof, and also includes a shape [symbol] provided in the color “lemon yellow,” which was created and patented in Applicant's earlier U.S. Pat. No. 7,172,427. As illustrated in the tab of the index divider card 102, the phoneme [i] has the sound which is same sound as the combination of letters “ea” in the word “eat.” Each of the corresponding index cards 104 which are pulled out of the set 100 include one of the letter(s) or combinations of letter(s) which have the same sound as the phoneme [i]. These corresponding cards 104 (i.e., e, ee, ie, ey, ea and y) are also provided in the color “lemon yellow.” Since each index divider card 102 and corresponding set of index cards 104 are given a specific unique color, a student with hearing disabilities and/or speech impairments can recognize the colors of the different sets of letters and combinations of letters, and then select the specific set of the letters and combinations of letters having the same color “lemon yellow” that match the shape [symbol] on the index card 102 representing the phoneme [i], also provided in the same “lemon yellow” color. Accordingly, when a teacher is teaching a student with hearing disabilities and/or speech impairments with the present inventive concept to spell the word “eat,” the teacher can present the index card with the shape [symbol] (having the color “lemon yellow”; see FIG. 3F) to the student together with an index card with a shape [symbol] (having the color “light turquoise”; see FIG. 4N) representing the phoneme [t], which was also created and patented in Applicant's earlier U.S. Pat. No. 7,172,427. With the shape [symbol] and the shape [symbol] being presented to the student with hearing disabilities and/or speech impairments, the student will be able to recognize the colors “lemon yellow” and “light turquoise,” and then be able to select the cards having the letter(s) and/or combination of letter(s) in the color “lemon yellow” and the cards having the letter(s) and/or combination of letter(s) in the color “light turquoise.” From here the student will be able to select the cards having e, ee, ie, ey, ea and y and the cards having t, tt and ed on them, and then determine that the cards “ea” and “t” spell the word “eat.”

It is noted that auditory sound recognition is a function of the left side of the brain. The recognition of color is a right brain function. Auditory processing and recognition of sound is often difficult and sometimes impossible for students with hearing disabilities or other speech sound disorders. Using the visual skills of their right brain to identify the specific colors and shapes of the present inventive concept (U.S. Pat. No. 7,172,427) in conjunction with the verbal production of the related phoneme, the deaf and speech sound disabled individuals have access and a way to identify, differentiate and remember specific sounds. Once awareness of these phonemes is established and related to specific colors and shapes, these can be used to introduce the letter or combination of letters that make up each phoneme. Together with the visual support and presence of specific shape and color in relationship to letters of the same color, the concept of spelling and reading specific American Engsh words becomes comprehensible.

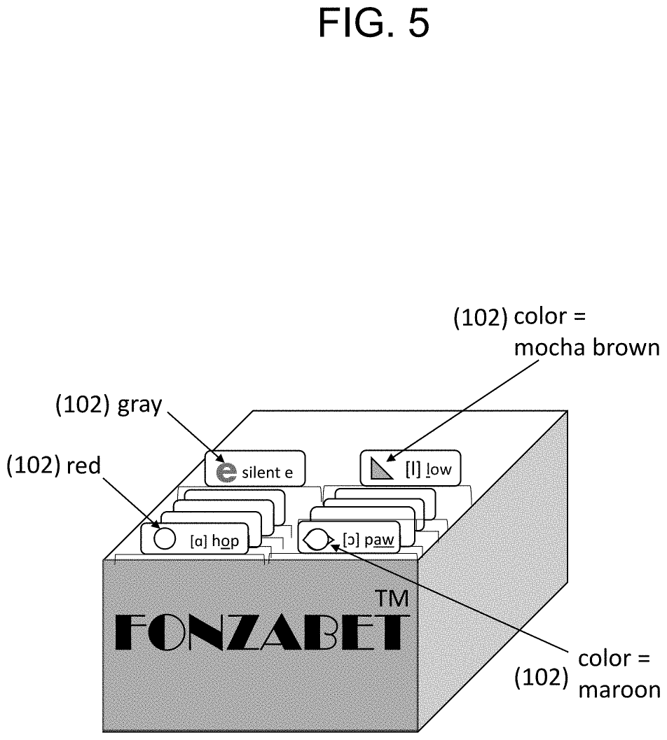

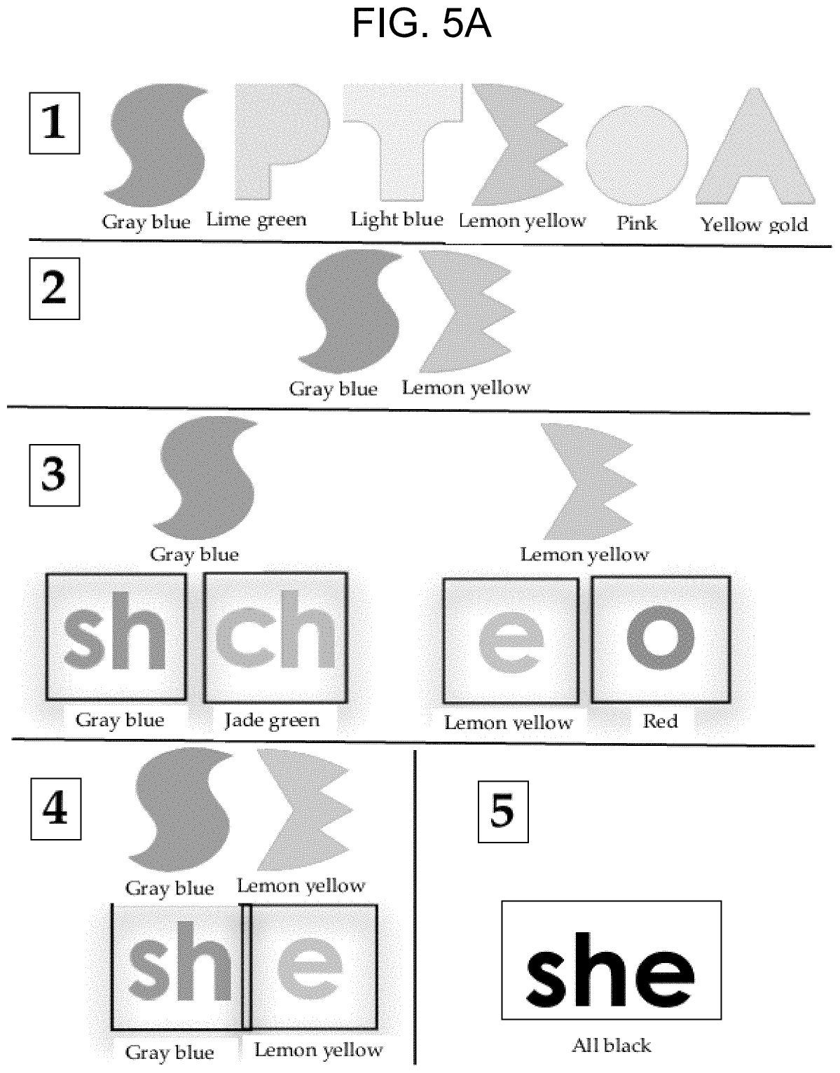

FIG. 5 illustrates the system described with respect to FIGS. 3A through 4X contained in a kit 100 or containerized collection in accordance with an exemplary embodiment of the present inventive concept. Each of the index cards 102 can be alternatively arranged such that the top tabs of each of the index cards 102 can been seen while in the kit or container. A set of cards including the letter(s) and/or combination(s) of letters that have the same sound as the phoneme on the corresponding index card 102 are placed behind the corresponding index card 102.

FIG. 5A illustrates the system and the process beginning with shapes from the applicant's former U.S. Pat. No. 7,172,427, and thereafter, using the system described with respect to FIGS. 3A through 5. For example, the word “she” has only two sounds, also known as “phonemes,” which make up a word. The letters “sh” and “e” make the corresponding sounds in this word. There are over six letter combinations in English that make the first sound (illustrated in FIG. 4Z), one being the letter combination “sh”. There are over six letter or letter combinations in English that make the second sound (illustrated in FIG. 4Y) one of these letters being “e”. Beginning the process, the teacher uses the Applicant's invention disclosed in U.S. Pat. No. 7,172,427. Six sounds/phonemes are chosen to review, which include the “sh” sound, which is always depicted by the gray-blue shape: [symbol] and the “e” sound, which is always depicted by the lemon-yellow shape [symbol] . Two more consonant shapes and two more vowel shapes are included in the choices that make up the array of colored shapes illustrated in step 1 of FIG. 5A. These sounds have all been introduced to the student in a previous lesson. At the beginning of this process the student chooses each sound shape individually from a container, labels them successfully and places them in this array. The next part in the process, is to teach the student to build the word “she” with the sound shapes using the system as follows. First, the student is requested to sound out the word “she,” and identify the first sound. Then the student is requested to select, among the array, the shape that represent the sound “sh.” Once the student chooses the shape [symbol] from among the array of shapes to sound “sh,” the student is then requested to identify the last sound in the word “she”. When the “e” sound is identified, the student selects the [symbol] from among the array of colored shapes illustrated in step 1 that represent the sound “e.” Once the student chooses the shape [symbol] from among the array of shapes to sound e the two shapes [symbol] and [symbol] are placed together as illustrated in step 2 of FIG. 5A. Once the student can do this independently, without prompting, they are ready to learn to spell the word using the index cards including the letters and letter combinations according to the present inventive concept. Since the letters and letter combinations of the present inventive concept are grouped and made up of the same colors as the shapes representing each of the phonemes, the students will be successful in their choices. For example, as illustrated in step 3 of FIG. 5A, given the letter combination choices “sh” and “ch,” the student will recognize that the letter combination “sh” is in the same color as the shape [symbol] , and therefore the student will correctly choose the letter combination “sh.” Then given the letter choices “e” and “o,” the student will recognize that the letter “e” is in the same color as the shape [symbol] , and therefore the student will correctly choose the letter “e,” As a result of the student's choices of “sh” and “e” and putting the letter combination “sh” together with the letter “e,” as illustrated in step 4 of FIG. 5A the student has correctly and successfully spelled the word “she.” Then the teacher can present a monochromatic version of the word “she” for the student to read, as illustrated in step 5 of FIG. 5A.

As pointed out previously, auditory sound recognition is a function of the left side of the brain. The recognition of color is a right brain function. Auditory processing and recognition of sound is often difficult and sometimes impossible for a student with hearing disabilities or other speech sound disorders. Using the visual skills of their right brain to identify the specific colors and shapes of the present inventive concept (U.S. Pat. No. 7,172,427) in conjunction with the verbal production of the related phoneme, the deaf and speech sound disabled individuals have access and a way to identify, differentiate and remember specific sounds. Once awareness of these phonemes is established and related to specific colors and shapes, these can be used to introduce the letter or combination of letters that make up each phoneme. Together with the visual support and presence of specific shape and color in relationship to letters of the same color, the concept of spelling and reading specific American Engsh words becomes comprehensible. The present inventive system which includes U.S. Pat. No. 7,172,427 augments the successful performance for students with speech sound disorders is possible.

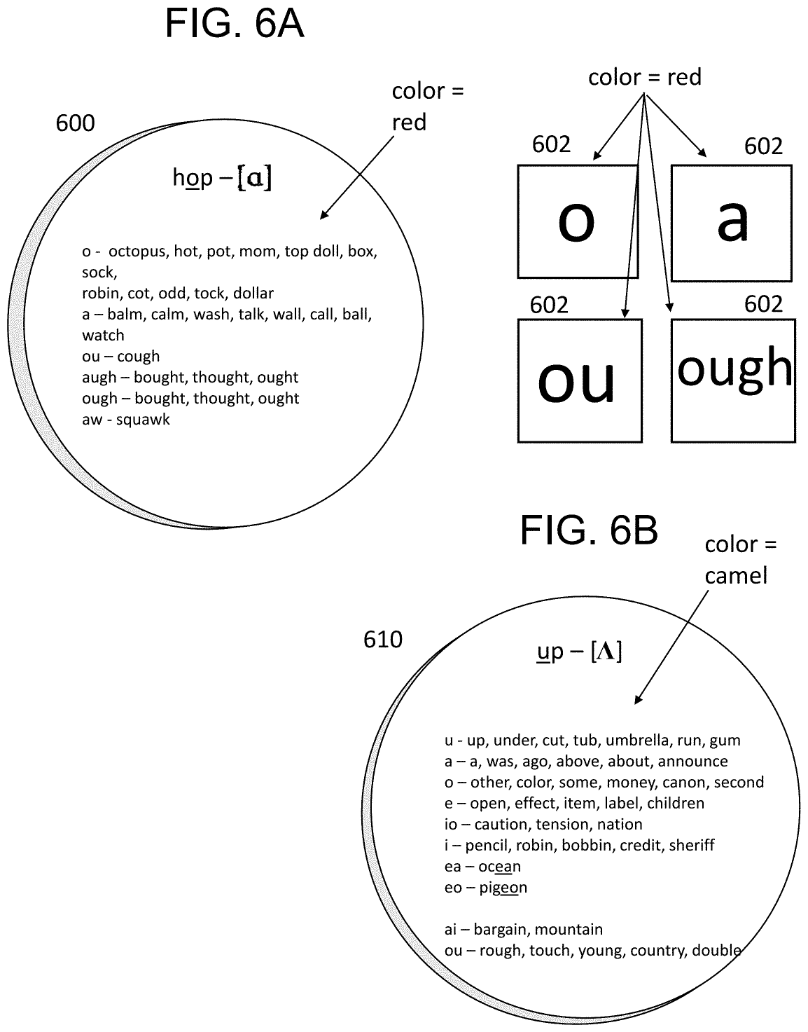

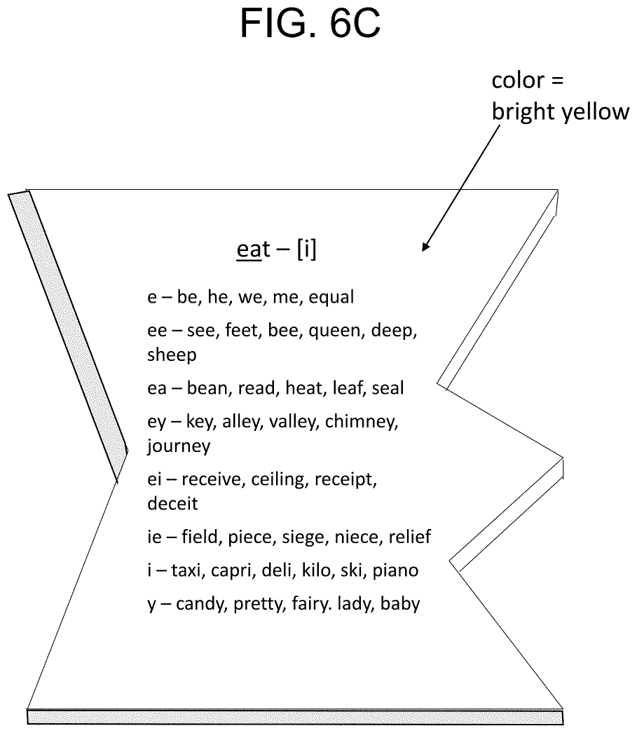

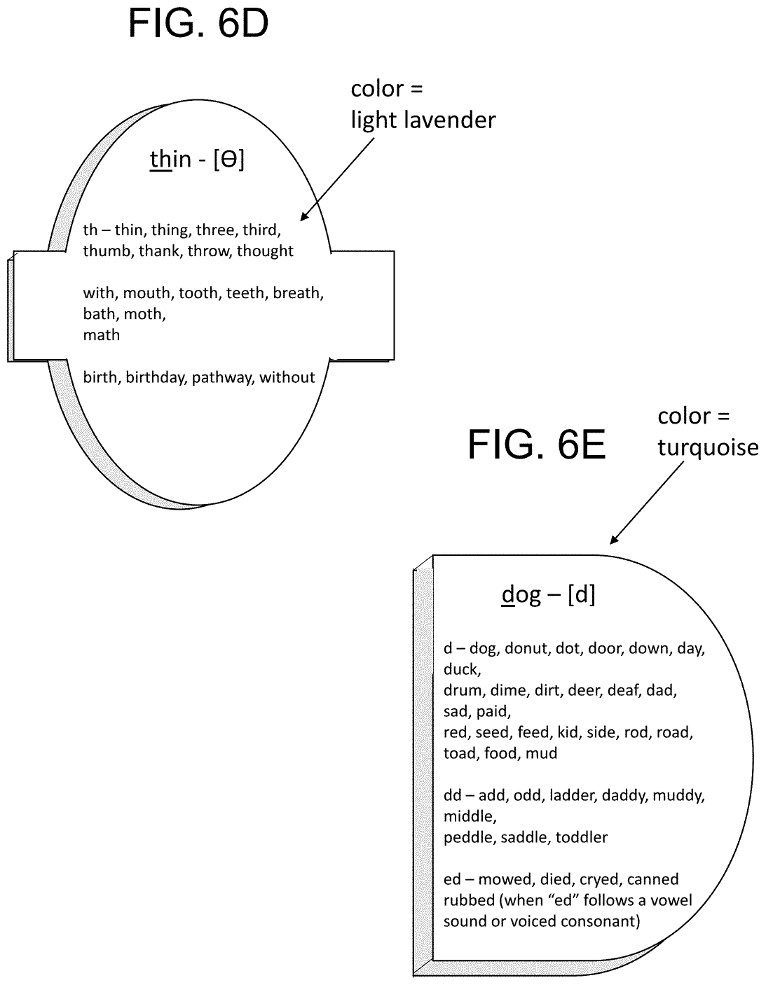

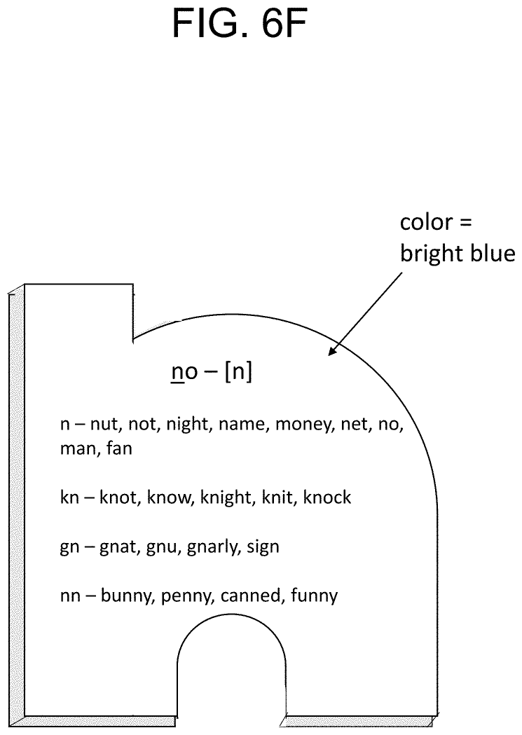

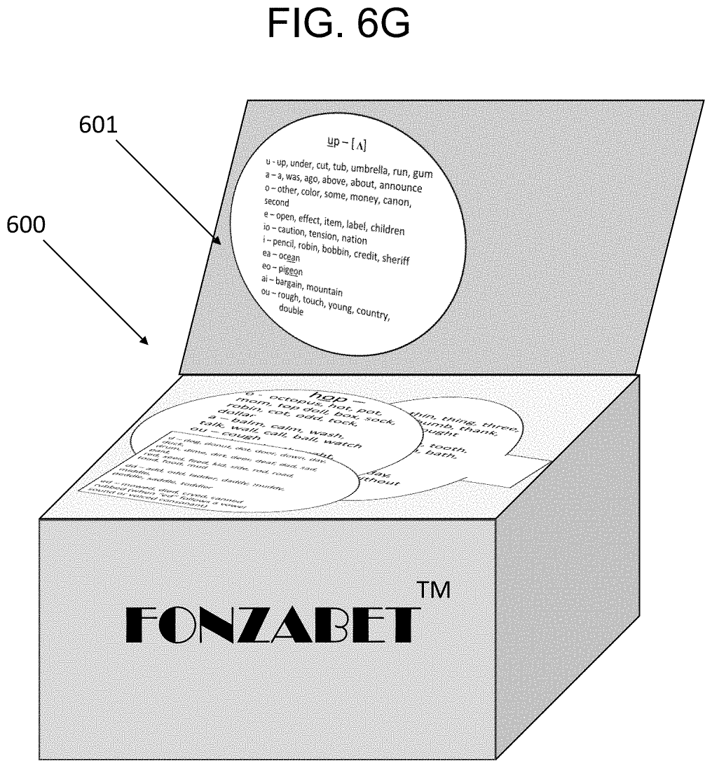

FIGS. 6A through 6D illustrate a system and process for teaching all of the American English language phoneme vowel sounds, consonant sound, vowel combination sounds and consonant combinations sounds to those with hearing and/or speech disabilities, according to another exemplary embodiment of the present inventive concept. More specifically, similar to the index card system and process described above and illustrated in FIGS. 3A through 4X, a complete system and process is provided for teaching all of the American English language phoneme vowel sounds, consonant sound, vowel combination sounds and consonant combination sounds to those with hearing and/or speech disabilities, according to another exemplary embodiment of the present inventive concept. However, this system and process is provided in the form of three dimensional elements fabricated to a certain thickness and proportion suitable for physical demonstration or application. FIGS. 6A through 6D are just a few examples of the three dimensional elements according to this exemplary embodiment, and a complete set of three dimensional elements that are equal in number to the multiple index cards illustrated in FIGS. 3A through 4X are provided to represent each of the phonemes of the American English language.

FIG. 6A illustrates a three dimensional element 600 for the phoneme [α]. Written on the three dimensional element for the phoneme [α] is the word hop, illustrating the pronunciation of this phoneme. Also written on the three dimensional element for the phoneme [α] are each of the vowel and vowel combinations that are used to spell words using this phoneme sound, together with words including these vowel and vowel combinations. Moreover, this three dimensional element for the phoneme [α] can also be provided in the color “red” to represent the phoneme sound for phoneme [α], similar to the index card according to the exemplary embodiment illustrated in FIG. 3I. In addition to the three dimensional element illustrated in FIG. 6A are a set of corresponding cards 602 (or other three dimensional elements), each including a letter or a combination of letters that make the same sound as the phoneme [α]. These corresponding cards or other three dimensional elements with a letter or a combination of letters that make the same sound as the phoneme [α] are also provided in the same color red. Similar sets of corresponding cards or other three dimensional elements are provided for each of the three dimensional elements illustrated in FIGS. 6B through 6F. These three dimensional elements illustrated in FIGS. 6A through 6G can alternatively be provided as two dimensional elements, which will provide the same system and functionality as the described three dimensional elements.

FIG. 6B illustrates a three dimensional element 610 for the phoneme [Λ]. Written on the three dimensional element [symbol] for the phoneme [Λ] is the word up, illustrating the pronunciation of this phoneme. Also written on the three dimensional element for the phoneme [Λ] are each of the vowel and vowel combinations that are used to spell words using this phoneme sound, together with words including these vowel and vowel combinations. Moreover, this three dimensional element for the phoneme [Λ] can also be provided in the color “camel” to represent the phoneme sound for phoneme [Λ], similar to the index card according to the exemplary embodiment illustrated in FIG. 3A. Similar to FIG. 6A, a set of corresponding cards or other three dimensional elements, each including a letter or a combination of letters that make the same sound as the phoneme [Λ] are also provided. These corresponding cards or other three dimensional elements with a letter or a combination of letters that make the same sound as the phoneme [Λ] are also provided in the same color camel.

FIG. 6C illustrates a three dimensional element for the phoneme [i]. Written on the three dimensional element for the phoneme [i] is the word eat, illustrating the pronunciation of this phoneme. Also written on the three dimensional element for the phoneme [i] are each of the vowel and vowel combinations that are used to spell words using this phoneme sound, together with words including these vowel and vowel combinations. Moreover, this three dimensional element for the phoneme [i] can also be provided in the color “bright yellow” to represent the honeme sound for phoneme [i], similar to the index card according to the exemplary embodiment illustrated in FIG. 3F. Similar to FIG. 6A, a set of corresponding cards or other three dimensional elements, each including a letter or a combination of letters that make the same sound as the phoneme [i] are provided. These corresponding cards or other three dimensional elements with a letter or a combination of letters that make the same sound as the phoneme [Λ] are also provided in the same color bright yellow.

FIG. 6D illustrates a three dimensional element for the phoneme [θ]. Written on the three dimensional element for the phoneme [θ] is the word thin, illustrating the pronunciation of this phoneme. Also written on the three dimensional element for the phoneme [θ] is the consonant combination that is used to spell words using this phoneme sound, together with words including this consonant combinations. Moreover, this three dimensional element for the phoneme [θ] can also be provided in the color “light lavender” to represent the phoneme sound for phoneme [θ], similar to the index card according to the exemplary embodiment illustrated in FIG. 4L. Similar to FIG. 6A, a set of corresponding cards or other three dimensional elements, each including a letter or a combination of letters that make the same sound as the phoneme [θ] are provide. These corresponding cards or other three dimensional elements with a letter or a combination of letters that make the same sound as the phoneme [θ] are also provided in the same color light lavender.

FIG. 6E illustrates a three dimensional element for the phoneme [d]. Written on the three dimensional element for the phoneme [θ] is the word thin, illustrating the pronunciation of this phoneme. Also written on the three dimensional element for the phoneme [d] are consonant and consonant combinations that are used to spell words using this phoneme sound, together with words including the consonant and consonant combinations. Moreover, this three dimensional element for the phoneme [d] can also be provided in the color “turquoise” to represent the phoneme sound for phoneme [d], similar to the index card according to the exemplary embodiment illustrated in FIG. 4O. Similar to FIG. 6A, a set of corresponding cards or three dimensional elements, each including a letter or a combination of letters that make the same sound as the phoneme [d] are provided. These corresponding cards or other three dimensional elements with a letter or a combination of letters that make the same sound as the phoneme [d] are also provided in the same color turquoise.

FIG. 6F illustrates a three dimensional element for the phoneme [n]. Written on the three dimensional element for the phoneme [n] is the word no, illustrating the pronunciation of this phoneme. Also written on the three dimensional element for the phoneme [n] are consonant and consonant combinations that are used to spell words using this phoneme sound, together with words including the consonant and consonant combinations. Moreover, this three dimensional element for the phoneme [n] can also be provided in the color “bright blue” to represent the phoneme sound for phoneme [n], similar to the index card according to the exemplary embodiment illustrated in FIG. 4J. Similar to FIG. 6A, a set of corresponding cards or three dimensional elements, each including a letter or a combination of letters that make the same sound as the phoneme [n] are provided. These corresponding cards or other three dimensional elements with a letter or a combination of letters that make the same sound as the phoneme [n] are also provided in the same color bright blue.

FIGS. 6A through 6F provide only a small number of the three dimensional elements (or two dimensional elements) according to this exemplary system and process. FIGS. 6A through 6F illustrate three examples representing phenome vowels and vowel combinations and three examples representing phenome consonants and consonant combinations, together with words using the phenome vowels and vowel combinations and phenome consonants and consonant combinations. Only six examples of the three dimensional elements are illustrated in order to provide brevity to the detailed description herein. However, the number of three dimensional elements can be equal in number to the number of index cards described and illustrated in the exemplary embodiments of FIGS. 3A through 4X, as well as providing the same information thereon. Moreover, as more phonemes may be added to the International Phonetic Chart, additional three dimensional elements may be added with corresponding vowel and/or vowel combinations (or consonant and/or consonant combinations) together with words using the same, along with unique colors and shapes to represent such newly added vowel and/or vowel combinations (or consonant and/or consonant combinations) without departing from the spirit of the present inventive concept.

The three dimensional elements according to this exemplary embodiment can be provided with a substantially rigid construction such that the visual phonemes enjoy the advantage of being capable of incorporating (in the fabrication thereof or attached thereto) magnetic characteristics for attachment to metal surfaces, as for example cabinets or refrigerator doors, as learning reminders. Alternatively, such substantially rigid elements may take forms (not shown) similar to well-known building blocks or provided with other structural capabilities of special application to playful learning. The solid or substantially rigid form of visual phonemes shown in FIGS. 6A through 6D also are considerably more durable and more easily cleaned.

These three dimensional elements can also be constructed of felt or felt-like material providing a substantially soft, flexible or malleable profile, or can be constructed of, for example, substantially rigid materials such as wood, ceramic, metal, plastic, tag board, or cardboard. It is to be noted that the system according to this exemplary embodiment is not limited to the few examples listed above, but can be constructed of any type of material(s), or digital representations, that provide the intended purposes of the present inventive concept, as described herein.

The shape of a representative visual phoneme in accordance with this inventive system and process may also be reminiscent of the Roman alphabet with which it is most often associated. As an example, FIG. 6C illustrates the visual phoneme [i] having the long vowel sound made when sounding the letter E. This phoneme is uniquely designated by the color bright yellow, notably corresponding with FIG. 3F.

FIG. 6G illustrates a system the system described with respect to FIGS. 6A through 6F contained in a kit 600 (or containerized collection) in accordance with an exemplary embodiment of the present inventive concept. Each of the three dimensional elements can be stored in the kit 600 for transportation or storage. The kit 600 can include a cover 601 that can open to a certain angle and act as a board to display one or more of the elements for viewing and teaching. The inside of the cover 601 can be made of a magnetic metal when the elements are made of a magnetic material, a Velcro type material when the elements have a Velcro backing, or any other attractive type of material such that the three dimensional elements can be removably attached to the inside of the cover 601 for display while in use.

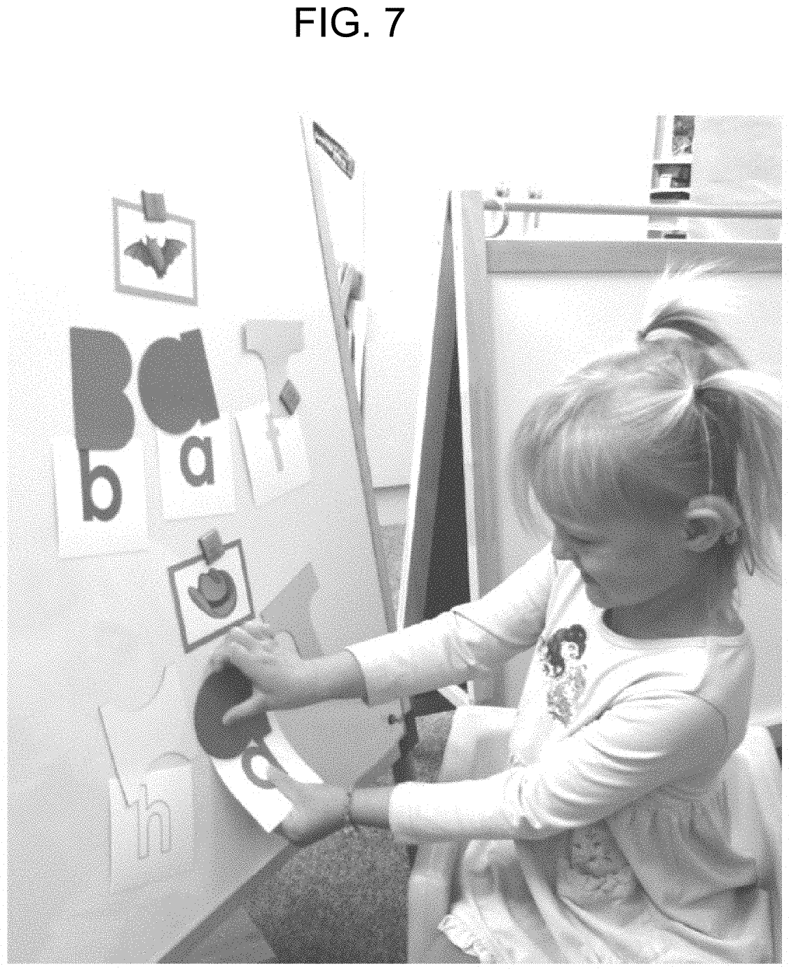

FIG. 7 illustrates another example of the system and process of the present inventive concept. First, a teacher will sound the word “bat.” The student will then choose from a set of pictures containing the target sounds. Three or four additional familiar sounds will be presented so that the student can demonstrate proficiency with identifying specific target sounds. Next the student identifies the first, next and last shapes to sound the word “bat” from an array of shapes presented to the student (i.e., [symbol] ). Then a student with hearing, auditory processing or speech disabilities can search among an array of cards (usually three or four additional cards having familiar sounds so that the student can demonstrate proficiency with identifying the specific target sound) until the student find the sets of cards which have the same respective colors as the colors of the shapes [symbol] , [symbol] and [symbol] . Among the sets of cards which have the same color as the shapes [symbol] , [symbol] and [symbol] the student can now easily find the letters b, a and t, which are in the same colors, respectively, and which correspond with and most likely sound the same as the shapes [symbol] , [symbol] and [symbol] . The student with hearing, auditory processing or speech disabilities has now associated specific letters with shapes and colors representing specific phonemes which sound the word “bat,” thus actually spelling the word “bat.” After this the hierarchical progression is for the teacher to ask the student to spell the word while the teacher writes the word on one color. The teacher can label the child as a speller. The child then reads the word and the teacher can announce that the child is a reader. This success contributes to self-confidence and a positive outlook on the process of spelling and reading.

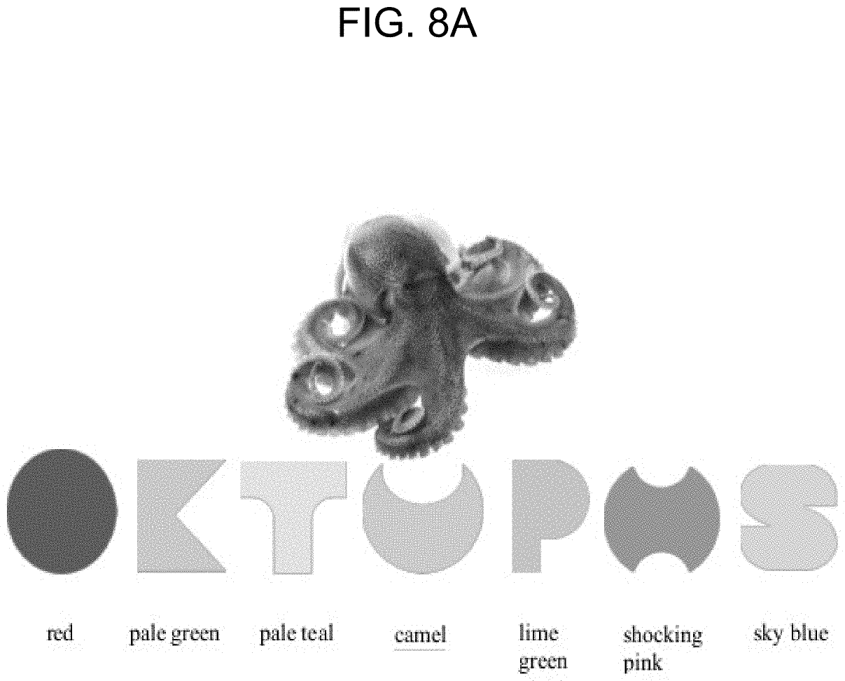

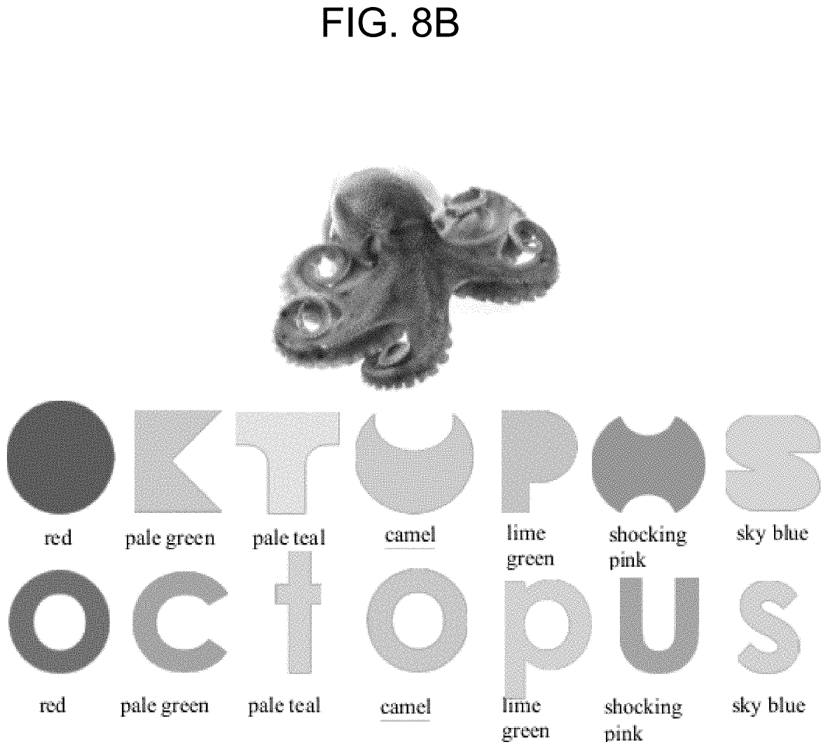

FIG. 8A illustrates a first step of another example of the process and system according to the present inventive concept. Here the teacher sounds the word “octopus.” The student will then sound the word back and then select from an array of shapes representing the phonemes that sound the word “octopus.” After the student correctly chooses the shapes representing the phonemes that sound the word “octopus,” and aligns these shapes, the student has successfully made the word “octopus” with sounds. The next step is for the student to build the word “octopus” with the correct letters and combinations of letters which sound each of the selected shapes, which is illustrated in FIG. 8B as described below.

FIG. 8B illustrates how the student with hearing, auditory processing or speech disabilities can find the letters o, c, t, o, p, u and s, which have the same color as the shapes set up in FIG. 8A. Upon aligning the letters found under the respective shapes, the student with hearing, auditory processing or speech disabilities has actually spelled out the word “octopus.”

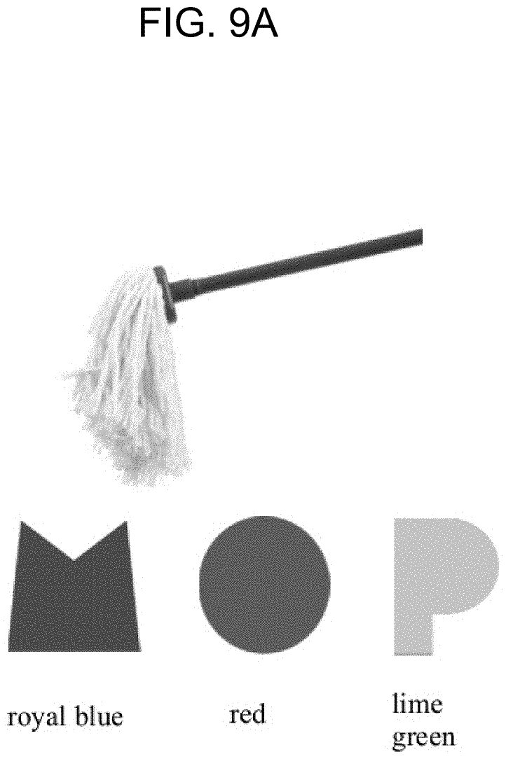

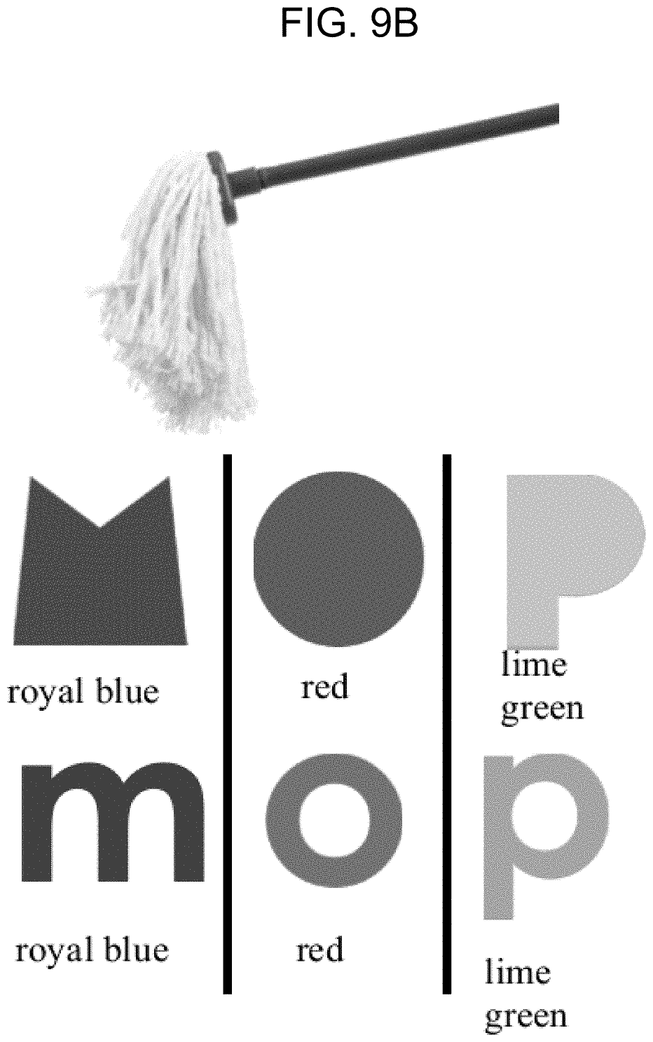

FIGS. 9A and 9B provide the same process as described with respect to FIGS. 8A and 8b, only for the word “mop” instead of the word “octopus.”

It is to be noted that that the colors of the shapes that represent each phoneme and the letters and letter combinations that make these phonemes in words are always the same. For example, the [p] phoneme is lime-green and any letter or letter combination that makes the [p] sound in words is lime-green. Depending on the material used to represent them, the tone, hue or intensity of the colors my vary. New phoneme colors also may be added.

It is also to be noted that this system may be adjusted to be representative of sounds and letters in other languages.

It is also to be noted that although the system currently utilizes the 40 main phonemes of the English language, it can be expanded to include more phonemes, including that of other languages.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a blue-ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system for teaching speech to individuals with hearing, auditory processing or speech disabilities using phonemes, the system comprising:
a plurality of unique shaped objects, each unique shaped object representing the same sound as one of the phonemes of the American English language among the plurality of well-established American English language phonemes and being provided in a unique color, and
a plurality of sets of index cards, each set of the plurality of sets of index cards corresponding to one of the unique shaped objects representing the sound of a corresponding phoneme and including:
an index card having one of the letters or combination of letters thereon that have the same sound as the corresponding unique shaped object for every letter or combination of letters which have the same sound as the corresponding unique shaped object representing the same sound as the corresponding phoneme and having that letter or combination of letters printed in the same color as that unique shaped object.

2. The system according to claim 1, further comprising:
a kit to contain each of the plurality of sets of index cards and together with a corresponding index divider card for each set of index cards, each divider card having:
a tab including the unique shaped object and corresponding phoneme thereon, and
a body section including each of the letters and combinations of letters thereon together with examples of words including those letters and combinations of letters.

3. A system for teaching speech to individuals with hearing, auditory processing or speech disabilities using phonemes, the system comprising:
a plurality of unique shaped three dimensional objects, each unique shaped three dimensional object representing the same sound as one of the phonemes of the American English language among the plurality of well-established American English language phonemes and being provided in a unique color and including the corresponding phoneme thereon and each of the letters and combinations of letters thereon together with examples of words including those letters and combinations of letters, and
a plurality of sets of index cards or secondary three dimensional objects, each set of the plurality of sets of index cards or secondary three dimensional objects corresponding to one of the unique shaped three dimensional objects representing the sound of a corresponding phoneme and including:
an index card or secondary three dimensional objects having one of the letters or combination of letters thereon that have the same sound as the corresponding unique shaped three dimensional object for every letter or combination of letters which have the same sound as the corresponding unique shaped three dimensional object representing the same sound as the corresponding phoneme and having that letter or combination of letters printed in the same color as that unique shaped object.

4. The system according to claim 3, wherein the plurality of unique shaped three dimensional objects and the plurality of sets of index cards or secondary three dimensional objects are formed of a flexible magnetic material.

5. The system according to claim 3, wherein a back surface of the plurality of unique shaped three dimensional objects and the plurality of sets of index cards or secondary three dimensional objects are formed of a magnetic material are formed of a hook and loop system such that the three dimensional elements and the plurality of sets of second three dimensional elements attract to and stick to the inside surface of the cover.

6. The system according to claim 3, wherein the plurality of unique shaped three dimensional objects and the plurality of sets of index cards or secondary three dimensional objects are formed of a flexible material.

7. The system according to claim 3, wherein the plurality of unique shaped three dimensional objects and the plurality of sets of index cards or secondary three dimensional objects are formed of a magnetic material are formed of a felt material.

8. The system according to claim 3, wherein the plurality of unique shaped three dimensional objects and the plurality of sets of index cards or secondary three dimensional objects are formed of a magnetic material are formed of a rubber material.

9. A process of teaching speech to individuals with hearing, auditory processing or speech disabilities, the process comprising:
presenting a picture of an object to be spelled out and requesting the individual to first pronounce the object;
providing a plurality of unique shaped objects to the individual, each unique shaped object representing the same sound as one of the phonemes of the American English language among the plurality of well-established American English language phonemes and being provided in a unique color;
instructing the individual to select each of the unique shaped objects which represent the phonemes that make the sound of the object in the picture one at a time so the selection of unique shaped objects are lined up to make the sound of the object in the picture;
providing a plurality of sets of index cards, each set of the plurality of sets of index cards corresponding to one of the unique shaped objects representing the sound of a corresponding phoneme and including:
an index card having one of the letters or combination of letters thereon that have the same sound as the corresponding unique shaped object for every letter or combination of letters which have the same sound as the corresponding unique shaped object representing the same sound as the corresponding phoneme and having that letter or combination of letters printed in the same color as that unique shaped object; and
instructing the individual to select each of the index cards having the letter or combination of letters thereon which match the color of the selected unique shaped objects; and
instructing the individual to build the word that sounds the object presented in the picture by aligning each of the index cards having the letter and/or combinations of letters directly under the corresponding lined up selected unique shaped objects.
